(19) United States
(12) Patent Application Publication
(10) Pub. No.: US 2025/0279908 A1
(43) Pub. Date: Sep. 4, 2025

(54) LOW ENERGY BROADCAST CONTROL INFORMATION FLOW FOR SYNCHRONIZING A BROADCASTER DEVICE AND ONE OR MORE PERIPHERAL DEVICES

(71) Applicant: QUALCOMM Incorporated, San Diego, CA (US)

(72) Inventors: Giriraj GOYAL, Bangalore (IN); Nitin Raghavendra KIDIYOOR, Bangalore (IN); Vishal AGARWAL, Bangalore (IN); Ravi SHEKHAR, Thubarahalli (IN)

(21) Appl. No.: 18/594,406

(22) Filed: Mar. 4, 2024

(51) Int. Cl. H04L 12/18

(52) U.S. Cl. CPC H04L 12/1881; H04L 12/1886; H04L 12/189

(57) ABSTRACT

This disclosure provides methods, components, devices and systems for Low Energy (LE) broadcast control information flow for synchronizing a broadcaster device and one or more peripheral devices. Some aspects more specifically relate to how a broadcaster device may indicate whether a control sub-event of a broadcast isochronous group (BIG) event is associated with vendor-specific communication and a direction of transmission associated with the control sub-event. The broadcaster device may provide such indications via packets sent during broadcast isochronous stream (BIS) events of the BIG event preceding the control sub-event. In some implementations, the broadcaster device may use a control sub-event transmission flag (CSTF) set equal to a value to indicate that an upcoming control sub-event is associated with vendor-specific communication and may use at least a portion of a control sub-event sequence number (CSSN) field to indicate whether the direction of transmission is broadcaster-to-peripheral or is peripheral-to-broadcaster.

### TECHNICAL FIELD

This disclosure relates generally to wireless communication and, more specifically, to Low Energy (LE) broadcast control information flow for synchronizing a broadcaster device and one or more peripheral devices.

### DESCRIPTION OF THE RELATED TECHNOLOGY

Wireless communication networks are widely deployed to provide various types of communication content such as voice, video, packet data, messaging, broadcast, and so on. Some wireless communication networks may be capable of supporting communication with multiple users by sharing the available system resources (such as time, frequency, or power). Further, a wireless communication network may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM), among other examples. Wireless communication devices may communicate in accordance with any one or more of such wireless communication technologies, and may include wireless stations (STAs), wireless access points (APs), user equipment (UEs), network entities, or other wireless nodes. A wireless personal area network (WPAN), which may include a Bluetooth connection, may provide for short range wireless connections between two or more paired wireless devices. For example, wireless devices (such as cellular phones) may utilize WPAN communications to exchange information such as audio signals with wireless headsets.

### SUMMARY

The systems, methods, and devices of this disclosure each have several innovative aspects, no single one of which is solely responsible for the desirable attributes disclosed herein.

One innovative aspect of the subject matter described in this disclosure can be implemented in a broadcaster device. The broadcaster device may include a processing system that includes processor circuitry and memory circuitry that stores code. The processing system may be configured to cause the broadcaster device to transmit, via a set of multiple broadcast isochronous streams (BISs) of a broadcast isochronous group (BIG) and during one or more first sub-events of a first BIG event, one or more first packets that indicate that a control sub-event of the first BIG event is associated with vendor-specific communication and communicate control information with one or more peripheral devices during the control sub-event in accordance with the one or more first packets indicating that the control sub-event is associated with the vendor-specific communication.

Another innovative aspect of the subject matter described in this disclosure can be implemented in a method for wireless communication by or at a broadcaster device. The method may include transmitting, via a set of multiple BISs of a BIG and during one or more first sub-events of a first BIG event, one or more first packets that indicate that a control sub-event of the first BIG event is associated with vendor-specific communication and communicating control information with one or more peripheral devices during the control sub-event in accordance with the one or more first packets indicating that the control sub-event is associated with the vendor-specific communication.

Another innovative aspect of the subject matter described in this disclosure can be implemented in a broadcaster device. The broadcaster device may include means for transmitting, via a set of multiple BISs of a BIG and during one or more first sub-events of a first BIG event, one or more first packets that indicate that a control sub-event of the first BIG event is associated with vendor-specific communication and means for communicating control information with one or more peripheral devices during the control sub-event in accordance with the one or more first packets indicating that the control sub-event is associated with the vendor-specific communication.

Another innovative aspect of the subject matter described in this disclosure can be implemented in a non-transitory computer-readable medium storing code for wireless communication by a broadcaster device. The code may include instructions executable by a processing system (including one or more processors) to transmit, via a set of multiple BISs of a BIG and during one or more first sub-events of a first BIG event, one or more first packets that indicate that a control sub-event of the first BIG event is associated with vendor-specific communication and communicate control information with one or more peripheral devices during the control sub-event in accordance with the one or more first packets indicating that the control sub-event is associated with the vendor-specific communication.

In some implementations of the method, broadcaster devices, and non-transitory computer-readable medium described herein, the one or more first packets further include a sequence number field and the sequence number field indicates a direction of transmission of the control information between the broadcaster device and the one or more peripheral devices in accordance with the one or more first packets indicating that the control sub-event may be associated with the vendor-specific communication.

In some implementations of the method, broadcaster devices, and non-transitory computer-readable medium described herein, a first bit pattern of the sequence number field indicates that the direction of transmission may be broadcaster-to-peripheral and a second bit pattern of the sequence number field indicates that the direction of transmission may be peripheral-to-broadcaster.

In some implementations of the method, broadcaster devices, and non-transitory computer-readable medium described herein, the sequence number field includes three bits, a first bit of the three bits indicates that the direction of transmission may be broadcaster-to-peripheral or that the direction of transmission may be peripheral-to-broadcaster, and a remainder of the three bits excluding the first bit indicates a sequence number that may be valid in accordance with the first bit indicating that the direction of transmission may be broadcaster-to-peripheral.

In some implementations of the method, broadcaster devices, and non-transitory computer-readable medium described herein, communicating the control information with the one or more peripheral devices may include operations, features, means, or instructions for receiving, during the control sub-event, a packet that includes the control information from a first peripheral device, of the one or more peripheral devices, in accordance with the direction of transmission and in accordance with a BIG event number corresponding to the first BIG event.

In some implementations of the method, broadcaster devices, and non-transitory computer-readable medium described herein, the first peripheral device may be associated with a first BIS, of the set of multiple BISs, that corresponds to a first BIS index, the first BIS index may be associated with the first BIG event, and receiving the packet from the first peripheral device during the control sub-event of the first BIG event may be in accordance with the first BIS index being associated with the first BIG event.

In some implementations of the method, broadcaster devices, and non-transitory computer-readable medium described herein, the first BIS index may be associated with the first BIG event in accordance with a modulo operation between the BIG event number and a quantity of the set of multiple BISs being equal to the first BIS index minus one.

Another innovative aspect of the subject matter described in this disclosure can be implemented in a peripheral device. The peripheral device may include a processing system that includes processor circuitry and memory circuitry that stores code. The processing system may be configured to cause the peripheral device to receive, via a BIS of a BIG and during one or more first sub-events of a first BIG event, one or more first packets that indicate that a control sub-event of the first BIG event is associated with vendor-specific communication and communicate control information with a broadcaster device during the control sub-event in accordance with the one or more first packets indicating that the control sub-event is associated with the vendor-specific communication.

Another innovative aspect of the subject matter described in this disclosure can be implemented in a method for wireless communication by or at a peripheral device. The method may include receiving, via a BIS of a BIG and during one or more first sub-events of a first BIG event, one or more first packets that indicate that a control sub-event of the first BIG event is associated with vendor-specific communication and communicating control information with a broadcaster device during the control sub-event in accordance with the one or more first packets indicating that the control sub-event is associated with the vendor-specific communication.

Another innovative aspect of the subject matter described in this disclosure can be implemented in a peripheral device. The peripheral device may include means for receiving, via a BIS of a BIG and during one or more first sub-events of a first BIG event, one or more first packets that indicate that a control sub-event of the first BIG event is associated with vendor-specific communication and means for communicating control information with a broadcaster device during the control sub-event in accordance with the one or more first packets indicating that the control sub-event is associated with the vendor-specific communication.

Another innovative aspect of the subject matter described in this disclosure can be implemented in a non-transitory computer-readable medium storing code for wireless communication by or at a peripheral device. The code may include instructions executable by a processing system (including one or more processors) to receive, via a BIS of a BIG and during one or more first sub-events of a first BIG event, one or more first packets that indicate that a control sub-event of the first BIG event is associated with vendor-specific communication and communicate control information with a broadcaster device during the control sub-event in accordance with the one or more first packets indicating that the control sub-event is associated with the vendor-specific communication.

In some implementations of the method, peripheral devices, and non-transitory computer-readable medium described herein, the one or more first packets further include a sequence number field and the sequence number field indicates a direction of transmission of the control information between the broadcaster device and the peripheral device in accordance with the one or more first packets indicating that the control sub-event may be associated with the vendor-specific communication.

In some implementations of the method, peripheral devices, and non-transitory computer-readable medium described herein, a first bit pattern of the sequence number field indicates that the direction of transmission may be broadcaster-to-peripheral and a second bit pattern of the sequence number field indicates that the direction of transmission may be peripheral-to-broadcaster.

In some implementations of the method, peripheral devices, and non-transitory computer-readable medium described herein, the sequence number field includes three bits, a first bit of the three bits indicates that the direction of transmission may be broadcaster-to-peripheral or that the direction of transmission may be peripheral-to-broadcaster, and a remainder of the three bits excluding the first bit indicates a sequence number that may be valid in accordance with the first bit indicating that the direction of transmission may be broadcaster-to-peripheral.

In some implementations of the method, peripheral devices, and non-transitory computer-readable medium described herein, communicating the control information with the broadcaster device may include operations, features, means, or instructions for transmitting, during the control sub-event of the first BIG event, a packet that includes the control information in accordance with the direction of transmission and in accordance with a BIG event number corresponding to the first BIG event.

In some implementations of the method, peripheral devices, and non-transitory computer-readable medium described herein, the BIS corresponds to a BIS index, the BIS index may be associated with the first BIG event, and transmitting the packet during the control sub-event of the first BIG event may be in accordance with the BIS index being associated with the first BIG event.

In some implementations of the method, peripheral devices, and non-transitory computer-readable medium described herein, the BIS index may be associated with the first BIG event in accordance with a modulo operation between the BIG event number and a quantity of a set of multiple BISs of the BIG being equal to the BIS index minus one.

Details of one or more implementations of the subject matter described in this disclosure are set forth in the accompanying drawings and the description below. Other features, aspects, and advantages will become apparent from the description, the drawings and the claims. Note that the relative dimensions of the following figures may not be drawn to scale.

### BRIEF DESCRIPTION OF THE DRAWINGS

FIG. 1 shows a pictorial diagram of an example wireless communication network.

FIG. 2 shows a pictorial diagram of another example wireless communication network.

FIGS. 3-5 show example signaling diagrams that support Low Energy (LE) broadcast control information flow for synchronizing a broadcaster device and one or more peripheral devices.

FIGS. 6 and 7 show example communication timelines that support LE broadcast control information flow for synchronizing a broadcaster device and one or more peripheral devices.

FIG. 8 shows an example process flow that supports LE broadcast control information flow for synchronizing a broadcaster device and one or more peripheral devices.

FIG. 9 shows a block diagram of an example wireless communication device that supports LE broadcast control information flow for synchronizing a broadcaster device and one or more peripheral devices.

FIG. 10 shows a block diagram of an example wireless communication device that supports LE broadcast control information flow for synchronizing a broadcaster device and one or more peripheral devices.

FIGS. 11 and 12 show flowcharts illustrating example processes performable by or at a broadcaster device that supports LE broadcast control information flow for synchronizing a broadcaster device and one or more peripheral devices.

FIGS. 13 and 14 show flowcharts illustrating example processes performable by or at a peripheral device that supports LE broadcast control information flow for synchronizing a broadcaster device and one or more peripheral devices.

Like reference numbers and designations in the various drawings indicate like elements.

### DETAILED DESCRIPTION

The following description is directed to some particular examples for the purposes of describing innovative aspects of this disclosure. However, a person having ordinary skill in the art will readily recognize that the teachings herein can be applied in a multitude of different ways. Some or all of the described examples may be implemented in any device, system or network that is capable of transmitting and receiving radio frequency (RF) signals according to one or more of the Institute of Electrical and Electronics Engineers (IEEE) 802.11 standards, the IEEE 802.15 standards, the Bluetooth® standards as defined by the Bluetooth Special Interest Group (SIG), or the Long Term Evolution (LTE), 3G, 4G, 5G (New Radio (NR)) or 6G standards promulgated by the 3rd Generation Partnership Project (3GPP), among others. The described examples can be implemented in any suitable device, component, system or network that is capable of transmitting and receiving RF signals according to one or more of the following technologies or techniques: code division multiple access (CDMA), time division multiple access (TDMA), orthogonal frequency division multiplexing (OFDM), frequency division multiple access (FDMA), orthogonal FDMA (OFDMA), single-carrier FDMA (SC-FDMA), spatial division multiple access (SDMA), rate-splitting multiple access (RSMA), multi-user shared access (MUSA), single-user (SU) multiple-input multiple-output (MIMO) and multi-user (MU)-MIMO (MU-MIMO). The described examples also can be implemented using other wireless communication protocols or RF signals suitable for use in one or more of a wireless personal area network (WPAN), a wireless local area network (WLAN), a wireless wide area network (WWAN), a wireless metropolitan area network (WMAN), a non-terrestrial network (NTN), or an internet of things (IoT) network.

In some wireless communication networks, such as Bluetooth Lower Energy (LE) (BLE) networks, a first wireless communication device may broadcast to (such as transmit to) one or more other wireless communication devices via one or more broadcast isochronous streams (BISs) of a broadcast isochronous group (BIG). The first wireless communication device, which may be understood as a broadcaster device, may broadcast one or more packets to the other wireless communication devices, which may be understood as peripheral devices, in accordance with transmission time windows of events and sub-events. For example, within a BIG event (a first transmission time window having a duration equal to a configured isochronous (ISO) interval), the broadcaster device may transmit one or more packets via one or more BIS events (a BIS event corresponding to a second transmission time window having a duration less than or equal to the configured ISO interval). A BIG event may include a control sub-event at or toward the end of the BIG event. If the control sub-event is present, a broadcaster device may transmit control information associated with the BIG to the peripheral devices via the control sub-event. In some networks, a flow of the control information within a BIG may be constrained to being from broadcaster-to-peripheral, such that a peripheral device may be unable to transmit control information to a broadcaster device. Further, in some networks, control sub-events may lack support for uses outside of a specification-defined purpose (such as a Bluetooth Special Interest Group (BT-SIG) standard defined purpose), which may hinder extension of LE broadcast to some use cases, such as use cases in which communication of vendor-specific information supports or informs the use of LE broadcast.

Various aspects of the present disclosure relate generally to one or more configuration-based or signaling-based mechanisms according to which two or more wireless communication devices may support a bi-directional transfer of control information between a broadcaster and one or more broadcast receivers. Some aspects more specifically relate to how a broadcaster device may indicate whether a control sub-event of a BIG event is associated with vendor-specific communication and, if so, a direction of transmission associated with the control sub-event. In some examples, the broadcaster device may provide such indications via one or more packets, such as one or more BIS data protocol data units (PDUs), sent during a BIS event of the BIG event preceding the control sub-event. In some examples, the broadcaster device may use a control sub-event transmission flag (CSTF) set equal to a value, such as zero, to indicate that an upcoming control sub-event is associated with vendor-specific communication and may use a portion of (such as one bit of) a control sub-event sequence number (CSSN) field to indicate whether the direction of transmission is broadcaster-to-peripheral or is peripheral-to-broadcaster. In other words, a CSTF set to zero may specify or indicate a vendor-specific use and, when the CSTF is set to zero, the CSSN field may specify or indicate the use purpose. If the CSTF is set to zero and the CSSN is set to a default value, such as a bit pattern of all zeros, the control sub-event may not be present (such as not for a specification-defined purpose and not for vendor-specific communication). Various further aspects relate to clash avoidance schemes, power conservation schemes, use of an opcode to indicate whether the control information includes host-based information or controller-based information, and/or periodic advertising (PA), among others.

Particular aspects of the subject matter described in this disclosure can be implemented to realize one or more of the following potential advantages. In some examples, by indicating whether an upcoming control sub-event is associated with vendor-specific communication and a direction of transmission associated with the control sub-event, the described techniques can be used to dynamically allocate control sub-events for vendor-specific communication in a manner that supports a bi-directional transfer of control information between a broadcaster and one or more broadcast receivers. Accordingly, a broadcaster device or a broadcast receiver (such as a peripheral device) may provide vendor-specific information to support an applicable use case with a low-latency information flow and with relatively-low signaling overhead (such as with relatively-low bandwidth usage, such as by re-purposing bits from packets already transmitted). Further, in accordance with the described clash avoidance schemes, multiple peripheral devices may provide control information to a broadcaster device without (or with a relatively-low likelihood of) packet collisions, which may increase communication reliability and support higher data rates and greater spectral efficiency.

Additionally, in accordance with the described power conservation schemes, a broadcaster device may selectively monitor control sub-events associated with a peripheral-to-broadcaster information flow to achieve power savings or longer battery life while maintaining reliability (and sufficient opportunities) for peripheral-to-broadcaster information flow. Moreover, in accordance with use of an opcode to indicate whether the control information includes host-based information or controller-based information, a controller of a device receiving the control information may use fewer processing resources to parse the control information. Further, in accordance with a PA signaling mechanism, a broadcaster device and one or more peripheral devices may support the bi-directional transfer of control information with relatively-low complexity by limiting a quantity of potential interpretations of signaled bits.

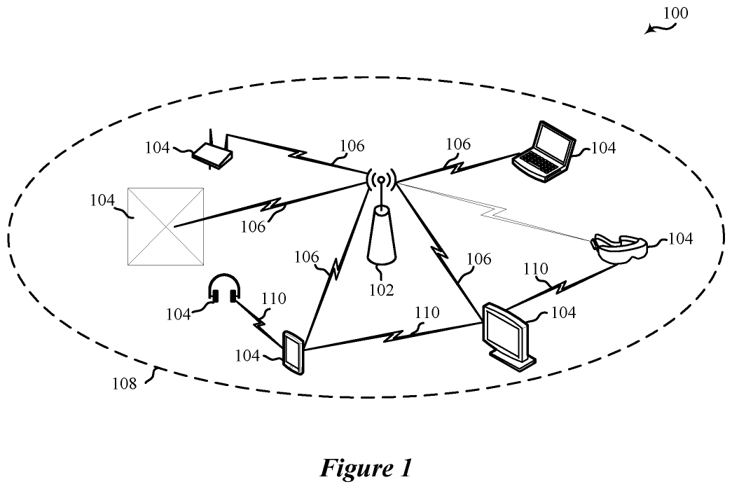

FIG. 1 shows a pictorial diagram of an example wireless communication network 100. According to some aspects, the wireless communication network 100 may include or refer to a wireless personal area network (WPAN), a wireless local area network (WLAN), or a Wi-Fi network. For example, the wireless communication network 100 can be a network implementing at least one of the IEEE 802.11 family of wireless communication protocol standards (such as defined by the IEEE 802.11-2020 specification or amendments thereof including, but not limited to, 802.11ay, 802.11ax, 802.11az, 802.11ba, 802.11bc, 802.11bd, 802.11bc, 802.11bf, and 802.11bn). In some other examples, the wireless communication network 100 can be an example of a cellular radio access network (RAN), such as a 5G or 6G RAN that implements one or more cellular protocols such as those specified in one or more 3GPP standards. In some other examples, the wireless communication network 100 can include a WLAN that functions in an interoperable or converged manner with one or more cellular RANs to provide greater or enhanced network coverage to wireless communication devices within the wireless communication network 100 or to enable such devices to connect to a cellular network's core, such as to access the network management capabilities and functionality offered by the cellular network core. In some other examples, the wireless communication network 100 can include a WLAN that functions in an interoperable or converged manner with one or more personal area networks, such as a network implementing Bluetooth or other wireless technologies, to provide greater or enhanced network coverage or to provide or enable other capabilities, functionality, applications or services.

The wireless communication network 100 may include numerous wireless communication devices including at least one wireless access point (AP) 102 and any number of wireless stations (STAs) 104. While only one AP 102 is shown in FIG. 1, the wireless communication network 100 can include multiple APs 102. The AP 102 can be or represent various different types of network entities including, but not limited to, a home networking AP, an enterprise-level AP, a single-frequency AP, a dual-band simultaneous (DBS) AP, a tri-band simultaneous (TBS) AP, a standalone AP, a non-standalone AP, a software-enabled AP (soft AP), and a multi-link AP (also referred to as an AP multi-link device (MLD)), as well as cellular (such as 3GPP, 4G LTE, 5G or 6G) base stations or other cellular network nodes such as a Node B, an evolved Node B (eNB), a gNB, a transmission reception point (TRP) or another type of device or equipment included in a radio access network (RAN), including Open-RAN (O-RAN) network entities, such as a central unit (CU), a distributed unit (DU) or a radio unit (RU).

Each of the STAs 104 also may be referred to as a mobile station (MS), a mobile device, a mobile handset, a wireless handset, an access terminal (AT), a user equipment (UE), a subscriber station (SS), or a subscriber unit, among other examples. The STAs 104 may represent various devices such as mobile phones, other handheld or wearable communication devices, netbooks, notebook computers, tablet computers, laptops, Chromebooks, augmented reality (AR), virtual reality (VR), mixed reality (MR) or extended reality (XR) wireless headsets or other peripheral devices, wireless earbuds, other wearable devices, display devices (such as TVs, computer monitors or video gaming consoles), video game controllers, navigation systems, music or other audio or stereo devices, remote control devices, printers, kitchen appliances (including smart refrigerators) or other household appliances, key fobs (such as for passive keyless entry and start (PKES) systems), Internet of Things (IoT) devices, and vehicles, among other examples.

The STAs 104 may be examples of central devices (such as source devices) or may be examples of peripheral devices (such as sink devices) implementing WLAN communications (such as Wi-Fi communications) or Bluetooth communications. For example, central devices may include cell phones, UEs, wireless STAs, mobile stations, personal digital assistant (PDAs), other handheld devices, netbooks, notebook computers, tablet computers, laptops, broadcaster devices, or some other suitable terminology. Peripheral devices may include Bluetooth-enabled devices capable of pairing with other Bluetooth-enabled devices (such as central devices) or otherwise receiving unicast or broadcast Bluetooth communication and may include wireless audio devices (such as headsets, earbuds, speakers, carpieces, or headphones), display devices (such as TVs, glasses, or computer monitors), microphones, meters, or valves.

Bluetooth communications may refer to a short-range communication protocol and may be used to connect and exchange information between central devices and peripheral devices (such as between mobile phones, computers, digital cameras, wireless headsets, speakers, keyboards, mice or other input peripherals, and similar devices). Bluetooth systems (such as aspects of wireless communication network 100) may be organized using a central-peripheral relationship employing a time-division duplex protocol having, for example, defined time slots of 625 microseconds, in which transmission alternates between the central device (such as a source device) and one or more peripheral devices (such as sink devices). As such, in some examples, a device may be referred to as either a central device or a peripheral device based on the Bluetooth role configuration of the device. That is, designation of a device as either a central device or a peripheral device may not necessarily indicate a distinction in device capability, but rather may refer to or indicate roles held by the device in the wireless communication network 100. Generally, a central device may refer to a wireless communication device capable of wirelessly exchanging data signals with another device (such as a peripheral device), and a peripheral device may refer to a device operating in a peripheral role, or to a short-range wireless communication device capable of exchanging data signals with the central device (such as using Bluetooth communication protocols).

A Bluetooth-enabled device may be compatible with certain Bluetooth profiles to use desired services. A Bluetooth profile may refer to a specification regarding an aspect of Bluetooth-based wireless communications between devices. That is, a profile specification may refer to a set of instructions for using the Bluetooth protocol stack in a certain way, and may include information such as suggested user interface formats or particular options and parameters at each layer of the Bluetooth protocol stack. For example, a Bluetooth specification may include various profiles that define the behavior associated with each communication endpoint to implement a specific use case. Profiles may thus generally be defined according to a protocol stack that promotes and allows interoperability between endpoint devices from different manufacturers through enabling applications to discover and use services that other nearby Bluetooth-enabled devices may be offering. The Bluetooth specification defines device role pairs (such as roles for a central device and a peripheral device) that together form a single use case called a profile (such as for communications between the central device and the peripheral device). One example profile defined in the Bluetooth specification is the Handsfree Profile (HFP) for voice telephony, in which one device (such as a central device) implements an Audio Gateway (AG) role and the other device (such as a peripheral device) implements a Handsfree (HF) device role. Another example is the Advanced Audio Distribution Profile (A2DP) for high-quality audio streaming, in which one device (such as central device) implements an audio source device (SRC) role and another device (such as peripheral device) implements an audio sink device (SNK) role.

For a commercial Bluetooth-enabled device that implements one role in a profile to function properly, another device that implements the corresponding role may be present within the radio range of the first device. For example, in order for an HF device such as a Bluetooth headset to function according to the Handsfree Profile, a device implementing the AG role (such as a cell phone) may have to be present within radio range. Likewise, in order to stream high-quality mono or stereo audio according to the A2DP, a device implementing the SNK role (such as Bluetooth headphones or Bluetooth speakers) may have to be within radio range of a device implementing the SRC role (such as a stereo music player).

The Bluetooth specification defines a layered data transport architecture and various protocols and procedures to handle data communicated between two devices that implement a particular profile use case. For example, various logical links are available to support different application data transport requirements, with each logical link associated with a logical transport having certain characteristics (such as flow control, acknowledgement mechanisms, repeat mechanisms, sequence numbering, or scheduling behavior. The Bluetooth protocol stack may be split in two parts: a controller stack including the timing critical radio interface, and a host stack handling high level data. The controller stack may be generally implemented in a low cost silicon device including one or more Bluetooth radios and one or more microprocessors. The controller stack may be responsible for setting up direct wireless communication links 110 such as asynchronous connection-less (ACL) links, (or ACL connections), synchronous connection orientated (SCO) links (or SCO connections), extended synchronous connection-oriented (eSCO) links (or eSCO connections), broadcast isochronous streams (BISs), connected isochronous streams (CISs), or other logical transport channel links.

In some examples, the controller stack may implement link management protocol (LMP) functions or low energy link layer (LELL) functions. The host stack may be generally implemented as part of an operating system, or as an installable package on top of an operating system. The host stack may be responsible for logical link control and adaptation protocol (L2CAP) functions, Bluetooth network encapsulation protocol (BNEP) functions, or service discovery protocol (SDP) functions. In some examples, the controller stack and the host stack may communicate via a host controller interface (HCI). In some other examples, (such as for integrated devices such as Bluetooth headsets), the host stack and controller stack may be run on the same microprocessor to reduce mass production costs. For such host-less systems, the HCI may be optional, and may be implemented as an internal software interface.

A direct wireless communication link 110 may be established between two Bluetooth-enabled devices (such as between a central device and a peripheral device) and may provide for communications or services (such as according to some Bluetooth profile). For example, a Bluetooth connection may be an eSCO connection for voice call (such as which may allow for retransmission) or an ACL connection for music streaming (such as A2DP), among other examples. For example, eSCO packets may be transmitted in predetermined time slots (such as 6 Bluetooth slots each for eSCO). The regular interval between the eSCO packets may be specified when the Bluetooth link is established. The eSCO packets to/from a specific peripheral device (such as a peripheral device) are acknowledged, and may be retransmitted if not acknowledged during a retransmission window. In addition, audio may be streamed between a central device and a peripheral device using an ACL connection (A2DP profile). In some examples, the ACL connection may occupy 1, 3, or 5 Bluetooth slots for data or voice. Other Bluetooth profiles supported by Bluetooth-enabled devices may include Bluetooth Low Energy (BLE) (such as providing considerably reduced power consumption and cost while maintaining a similar communication range) or human interface device profile (HID) (such as providing low latency links with low power requirements).

A device may, in some examples, be capable of both Bluetooth and WLAN communications. For example, WLAN and Bluetooth components may be co-located within a device, such that the device may be capable of communicating according to both Bluetooth and WLAN communication protocols, as each technology may offer different benefits or may improve user experience in different conditions. In some examples, Bluetooth and WLAN communications may share a same medium, such as the same unlicensed frequency medium. In such examples, a central device may support WLAN communications via an AP 102 (such as over communication links 106). The AP 102 and the associated central devices may represent a basic service set (BSS) or an extended service set (ESS). The various central devices in the network may be able to communicate with one another through the AP 102. In some examples, the AP 102 may be associated with a coverage area 108, which may represent a basic service area (BSA).

In some examples, STAs 104 may form networks without APs 102 or other equipment other than the STAs 104 themselves. One example of such a network is an ad hoc network (or wireless ad hoc network). Ad hoc networks may alternatively be referred to as mesh networks or peer-to-peer (P2P) networks. In some examples, ad hoc networks may be implemented within a larger network such as the wireless communication network 100. In such examples, while the STAs 104 may be capable of communicating with each other through the AP 102 using communication links 106, STAs 104 also can communicate directly with each other via direct wireless communication links 110. Additionally, two STAs 104 may communicate via a direct wireless communication link 110 regardless of whether both STAs 104 are associated with and served by the same AP 102. In such an ad hoc system, one or more of the STAs 104 may assume the role filled by the AP 102 in a BSS. Such a STA 104 may be referred to as a group owner (GO) and may coordinate transmissions within the ad hoc network. Examples of direct wireless communication links 110 include Bluetooth connections (such as CISs or BISs), Wi-Fi Direct connections, connections established by using a Wi-Fi Tunneled Direct Link Setup (TDLS) link, and other P2P group connections.

In some networks, the AP 102 or the STAs 104, or both, may support applications associated with high throughput or low-latency requirements, or may provide lossless audio to one or more other devices. For example, the AP 102 or the STAs 104 may support applications and use cases associated with ultra-low-latency (ULL), such as ULL gaming, or streaming lossless audio and video to one or more personal audio devices (such as peripheral devices) or AR/VR/MR/XR headset devices. In scenarios in which a user uses two or more peripheral devices, the AP 102 or the STAs 104 may support an extended personal audio network enabling communication with the two or more peripheral devices. Additionally, the AP 102 and STAs 104 may support additional ULL applications such as cloud-based applications (such as VR cloud gaming) that have ULL and high throughput requirements.

In some examples, content, media, or audio exchanged between a central device (such as a broadcaster device) and a peripheral device may originate from a WLAN. For example, in some examples, a central device may receive audio from an AP 102 (such as via WLAN communications), and the central device may relay or pass the audio to the peripheral device (such as via Bluetooth communications). In some examples, certain types of Bluetooth communications (such as such as high quality or high definition (HD) Bluetooth) may require enhanced quality of service (QOS). In some examples, delay-sensitive Bluetooth traffic may have higher priority than WLAN traffic.

As indicated above, in some implementations, the AP 102 and the STAs 104 may function and communicate (via the respective communication links 106) according to one or more of the IEEE 802.11 family of wireless communication protocol standards. These standards define the WLAN radio and baseband protocols for the physical (PHY) and MAC layers. The AP 102 and STAs 104 transmit and receive wireless communications (hereinafter also referred to as “packets” or “wireless packets”) to and from one another in the form of PHY PDUs (PPDUs).

Each PPDU is a composite structure that includes a PHY preamble and a payload that is in the form of a PHY service data unit (PSDU). The information provided in the preamble may be used by a receiving device to decode the subsequent data in the PSDU. In Bluetooth communication, communicating devices may use a single packet format for both advertising and data transmissions. The packet format may include a set of components including a preamble (which may be 1 octet in length), an access address (which may be 4 octets in length), a PDU (which may be between 2 and 257 octets in length, and a cyclic redundancy check (CRC) (which may be 3 octets in length).

The APs 102 and STAs 104 in the wireless communication network 100 may transmit PPDUs over an unlicensed spectrum, such as the 2.4 GHZ, 5 GHZ, 6 GHZ, 45 GHZ, and 60 GHz bands. Some examples of the APs 102 and STAs 104 described herein also may communicate in other frequency bands that may support licensed or unlicensed communications. For example, the APs 102 or STAs 104, or both, also may be capable of communicating over licensed operating bands, where multiple operators may have respective licenses to operate in the same or overlapping frequency ranges. Such licensed operating bands may map to or be associated with frequency range designations of FR1 (410 MHz-7.125 GHZ), FR2 (24.25 GHZ-52.6 GHZ), FR3 (7.125 GHZ-24.25 GHZ), FR4a or FR4-1 (52.6 GHz-71 GHZ), FR4 (52.6 GHZ-114.25 GHZ), and FR5 (114.25 GHZ-300 GHz). In some networks, Bluetooth communication may use the 2.4 GHz spectrum band, which may refer to a spectrum band of 2,400 MHZ-2,483.5 MHZ.

Each of the frequency bands may include multiple sub-bands and frequency channels (also referred to as subchannels). The terms “channel” and “subchannel” may be used interchangeably herein, as each may refer to a portion of frequency spectrum within a frequency band (such as a 20 MHz, 40 MHz, 80 MHZ, or 160 MHz portion of frequency spectrum) via which communication between two or more wireless communication devices can occur. For example, PPDUs may be transmitted over one or more of the 2.4 GHz, 5 GHZ, or 6 GHz bands, each of which is divided into multiple channels (such as 1 MHz channels or 2 MHz channels for Bluetooth communication). An AP 102 may determine or select an operating or operational bandwidth for the STAs 104 and select a range of channels within a band to provide that operating bandwidth. In some aspects, Bluetooth communication may divide transmitted data into packets and may transmit each packet on one of 79 designated Bluetooth channels. Each channel may have a bandwidth of 1 MHz. A Bluetooth device may perform a quantity of hops per second, which may refer to how the Bluetooth device switches from transmitting via a first channel to transmitting via a second channel. In some aspects, a Bluetooth device may perform approximately 1,600 hops per second, with adaptive frequency-hopping (AFH) enabled. BLE may use 2 MHz spacing, which may accommodate 40 channels.

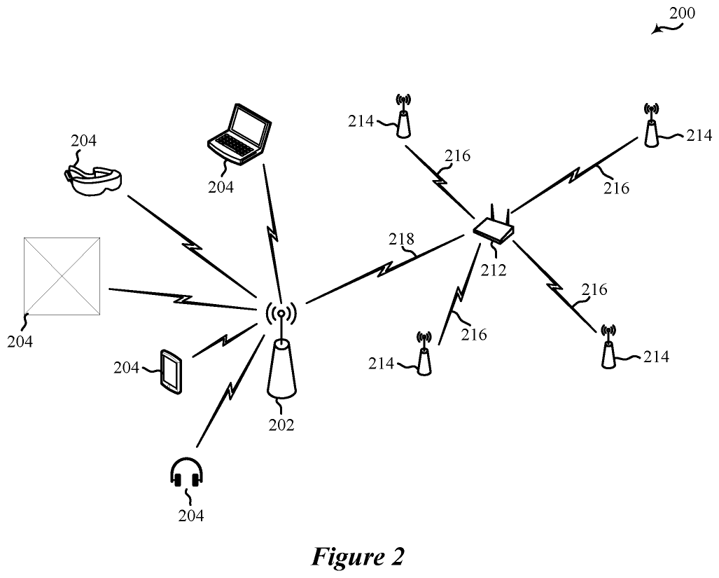

FIG. 2 shows a pictorial diagram of another example wireless communication network 200. According to some aspects, the wireless communication network 200 can be an example of a Bluetooth network, a mesh network, an IoT network, or a sensor network in accordance with one or more of the IEEE 802.11 family of wireless communication protocol standards. The wireless communication network 200 may include multiple wireless communication devices 214, which in some implementations may include APs 202, STAs 204, or both. The wireless communication devices 214 may represent various devices such as display devices (such as TVs, computer monitors, navigation systems, glasses, among others), music or other audio or stereo devices, remote control devices (“remotes” or “remote controls”), printers, kitchen or other household appliances, among other examples.

In some examples, the wireless communication devices 214 sense, measure, collect or otherwise obtain and process data and transmit such raw or processed data to an intermediate device 212 for subsequent processing or distribution. Additionally, or alternatively, the intermediate device 212 may transmit control information, digital content (such as audio or video data), configuration information or other instructions to the wireless communication devices 214. The intermediate device 212 and the wireless communication devices 214 can communicate with one another via wireless communication links 216. In some examples, the wireless communication links 216 include Bluetooth links or other PAN or short-range communication links.

In some examples, the intermediate device 212 also may be configured for wireless communication with other networks such as with a WLAN or a wireless (such as cellular) wide area network (WWAN), which may, in turn, provide access to external networks including the Internet. For example, the intermediate device 212 may associate and communicate, over a Wi-Fi link 218, with an AP 102 of a wireless communication network 200, which also may serve various STAs 104. In some examples, the intermediate device 212 is an example of a network gateway, for example, an IoT gateway. In such a manner, the intermediate device 212 may serve as an edge network bridge providing a Wi-Fi core backhaul for the IoT network including the wireless communication devices 214. In some examples, the intermediate device 212 can analyze, preprocess and aggregate data received from the wireless communication devices 214 locally at the edge before transmitting it to other devices or external networks via the Wi-Fi link 218. The intermediate device 212 also can provide additional security for the IoT network and the data it transports.

In some aspects, each of various devices (such as one or more STAs 104, one or more APs 102, one or more STAs 204, one or more APs 202, one or more intermediate devices 212, one or more wireless communication devices 214, or any combination thereof) may communicate in accordance with broadcast Bluetooth communication (such as LE broadcast ISO communication) and may be referred to herein as a broadcaster device (such as a broadcaster wireless communication device) or a peripheral device (such as a peripheral wireless communication device). Broadcast Bluetooth communication may involve one or more BISs of a BIG. A BIS may be understood as a logical transport that enables a device (such as an audio or display device) to transfer ISO data (framed or unframed). A BIS may support variable-size packets and the transmission of one or more packets in each ISO event, which may enable LE audio to support a range of data rates. A BIG may include a single BIS or may include two or more BISs that have a same ISO interval and that are expected to have a time relationship at the application layer. In an example in which a broadcaster device provides broadcast data to three peripheral devices, the broadcaster device may use a first BIS to transmit to a first peripheral device, a second BIS to transmit to a second peripheral device, and a third BIS to transmit to a third peripheral device. In such examples, a BIG of the broadcaster device may include the first BIS, the second BIS, and the third BIS. In some networks, a maximum quantity of BISs within a BIG may be 31.

For each BIS within a BIG, a schedule of transmission time slots (which may be referred to herein as events and sub-events) may be present. Each BIS event starts at a BIS anchor point and ends after its last sub-event. Each BIG event starts at a BIG anchor point and ends after a control sub-event, if present. If a control sub-event is not present, the BIG event ends at the end of the last BIS sub-event (or the last BIS event). A BIS sub-event enables an ISO broadcaster to transmit a BIS PDU and enables a synchronized receiver (such as a peripheral device) to receive the BIS PDU. The LL of the broadcaster device may transmit one BIS data PDU at the start of each sub-event of the ISO broadcasting event. For each BIS event, a source of the data (the broadcaster device) may send a burst of data including a quantity of payloads, with such a quantity being indicated by (and equal to) a burst number (BN). In some aspects, the sub-events of each BIS event may be partitioned into groups of BN sub-events. Each BIG event may optionally include a control sub-event. If a control sub-event is present, the LL of the broadcaster may transmit a single BIG control PDU at the start of the control sub-event to send control information associated with the BIG.

An ISO PDU (which may be referred to generally as a packet) may include a 16-bit header, a variable-sized payload, and an optional message integrity check (MIC) field. The format of the header and payload fields of the ISO PDU may be associated with (such as depend on) a type of the ISO PDU that is being used (such as transmitted). For example, an ISO PDU may be a CIS PDU or a BIS PDU when used on (such as transmitted via) a CIS or a BIS, respectively, and may have a format in accordance with whether the ISO PDU is a CIS PDU or a BIS PDU. A BIS PDU (which also may be referred to generally as a packet) may be a BIS data PDU or a BIG control PDU. A BIS data PDU may carry ISO data (which may be referred to as broadcast data) and a BIG control PDU may carry control information (such as control data) associated with a BIG.

A header of a BIS PDU may include a link layer (LL) identifier (LLID) field that indicates a type of content of the payload of the BIS PDU, a CSTF field that indicates whether a BIG control PDU is scheduled to be transmitted in a BIG event, a CSSN field (which may be referred to as a sequence number field) that indicates the start of a BIG event that includes the first transmission of a new BIG control PDU, and a length field that indicates a size (in octets) of the payload and MIC, if included. The LLID field may be 2 bits in length, the CSSN field may be 3 bits in length, the CSTF field may be 1 bit in length, and the length field may be 8 bits in length. In some networks, the header for a BIS PDU also may include 2 bits that may be reserved for future use (RFU). Such bits may be referred to as RFU bits. If a BIS PDU is a BIG control PDU, the payload of the BIS PDU includes an opcode field (having a length of 1 octet) and a control data field (have a length of between 0 and 250 octets). In some examples, a CSSN field may be relevant for standard (such as specification-defined) purpose when CSTF=1. If CSTF=1, the CSTF field indicates that a control sub-event is present after a last sub-event of the last BIS (within a BIG event). In such examples in which CSTF=1, the CSSN field may indicate a sequence number of the control information (which may be referred to as BIG Info) to be transmitted inside (such as during) the control sub-event. Thus, a CSSN number may help a receiver to choose the control sub-event or not. For example, if it is the CSSN belonging to a peripheral's most recent past control information that the peripheral received, the peripheral may ignore the control sub-event (as the control sub-event includes control information that is a retransmission of the same control information that the peripheral has already received).

For example, a broadcaster device may update a channel map (such as a set of frequencies used for broadcasting) via a control sub-event and, accordingly, the broadcaster device may transmit control information with the updated channel map during the control sub-event. If the broadcaster device transmits the updated channel map for the first time, the broadcaster device may set CSSN=0 (in one or more media packets prior to the control sub-event). A peripheral device may receive the one or more media packets containing CSTF=1 and CSSN=0 (indicating that the control information to be transmitted in the upcoming control sub-event has a sequence number of 0. The peripheral device may receive the control information (such as information indicative of the updated channel map) via the control sub-event accordingly. The broadcaster device may repeat the updated channel map several times (such as across multiple control sub-events of multiple BIG events) to increase a likelihood that all peripheral devices successfully receive the updated channel map. The peripheral device may receive media packets again in one or more subsequent BIG events and may notice (such as determine, identify, decode, or parse) that CSTF=1 and CSSN=0. Thus, the peripheral device may not open a receiver of the peripheral device in the control sub-events of the subsequent BIG event(s) because the peripheral device has already received the control information corresponding to CSSN=0.

If the broadcaster device updates the channel map again (such as a second updated channel map), the broadcaster device may set the header of media packets such that CSTF=1 and, for example, CSSN=1. In other words, the broadcaster device may increment the CSSN by 1. If the peripheral device receives, decodes, or parses the media packets with CSTF=1 and CSSN=1, the peripheral device may select to listen to the control information conveyed via the upcoming control sub-event because the control information will be new to the peripheral device.

In some LE broadcast ISO networks, data traffic may be unidirectional from a broadcaster device (which may be equivalently referred to as a broadcasting device) to one or more peripheral devices. Thus, in such networks, devices may lack a feedback or acknowledgment protocol, which may make broadcast ISO traffic relatively unreliable (at least in some channel conditions, and as compared to networks that support bi-directional traffic). For example, some Bluetooth networks may lack a mechanism for control information flow from a broadcast receiver (such as a peripheral device) to a broadcaster. In addition, such Bluetooth networks may lack a mechanism for proprietary (such as manufacturer- or vendor-specific) control information flow from the broadcaster to one or more broadcast receivers. A BIS may support multiple retransmissions to increase the reliability of packet delivery (such as to compensate for the lack of an acknowledgment protocol), but use of multiple retransmissions may still be insufficient to support use cases that might expect or rely on a control information exchange (such as a bi-directional exchange of control information) between a broadcaster and one or more broadcast receivers. Such use cases may include use cases for private, semi-private, public, or otherwise local broadcasting such as within home theaters or within in-vehicle entertainment and information systems such as in a car, tourist bus, or the like.

In accordance with some example implementations disclosed herein, a broadcaster device and one or more peripheral devices may support a signaling mechanism according to which the broadcaster device and the one or more peripheral devices can coordinate on whether a control sub-event is usable for a specification-defined purpose or is usable for vendor-specific (such as manufacturer-specific) communication and on a direction of transmission within the control sub-event. For example, the broadcaster device may transmit one or more packets (such as BIS PDUs, such as BIS data PDUs) via one or more sub-events of a BIG event and at least one of (in some examples, each of) the packets may include an indication of whether an upcoming control sub-event of the BIG event is usable for a specification-defined purpose or is usable for vendor-specific communication. Such an indication may be conveyed via, for example, a CSTF, which may be equivalently referred to as a CNTF. A CSTF (or CNTF) may be a transmission flag field that an LL (of the broadcaster device) uses to indicate whether a BIG control PDU is scheduled to be transmitted in a BIG event (such as in the BIG event within which the BIS data PDU including the CSTF is transmitted).

In some implementations, the broadcaster device may set the CSTF to be equal to 1 (CSTF=1) to indicate that the control sub-event of the BIG event is present and used for a specification-defined purpose and may set the CSTF to be equal to 0 (CSTF=0) to indicate that the control sub-event is present and used for vendor-specific communication (instead of for the specification-defined purpose). The packets (such as the BIS data PDUs) may further include a sequence number field (such as a CSSN field), which may serve a specification-defined purpose when CSTF=1 and may be unused (or, in other words, lack a specification-defined purpose) when CSTF=0. Accordingly, in some implementations, the broadcaster device and the peripheral device(s) may use the sequence number field to convey or parse (such as provide or obtain) additional information associated with the vendor-specific communication when CSTF=0 (as the devices may not be constrained to using the sequence number field for a specification-defined purpose when CSTF=0).

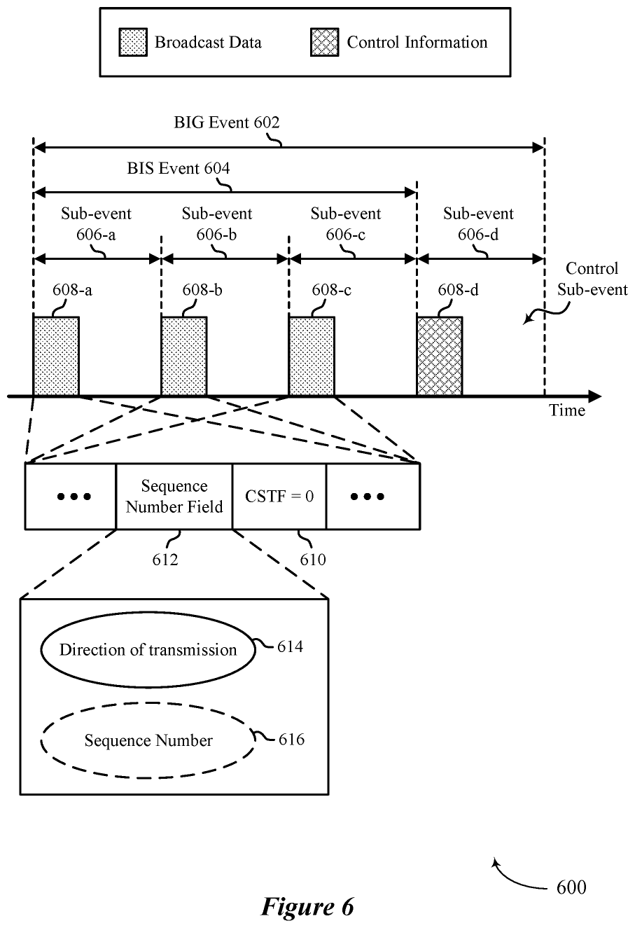

In some examples, the broadcaster device may use the sequence number field to indicate a direction of transmission of the vendor-specific information between the broadcaster device and the peripheral device(s). For example, a first bit pattern of the sequence number field may indicate that the direction of transmission is broadcaster-to-peripheral and a second bit pattern may indicate that the direction of transmission is peripheral-to-broadcaster. Additional details relating to such uses of a CSTF and a sequence number field are illustrated by and described with reference to FIG. 6.

The broadcaster device and the peripheral device(s) may support an interpretation of the CSTF and CSSN fields to be indicative of vendor-specific communication (if, for example, CSTF=0). In some examples, the broadcaster device and the peripheral device(s) may support such an interpretation in accordance with an indication, from the broadcaster device (such as via PA), of a manufacturer or vendor associated with the broadcaster device. In such examples, the peripheral device(s) may activate and employ the interpretation if the peripheral device(s) are associated with the same manufacturer or vendor as the broadcaster device. In some implementations, the broadcaster device may further indicate (via the PA) a version number of the broadcaster device. Thus, the broadcaster device may advertise the manufacturer or vendor of the broadcaster device and the version number of the broadcaster device. In such implementations, the peripheral device(s) may activate and employ the interpretation if the peripheral device(s) are associated with the same manufacturer or vendor as the broadcaster device and if the version number of the broadcaster device is associated with support for interpretation (such as if the broadcaster device has a capability, of which the version number of the broadcaster device can be indicative, to indicate whether an upcoming control sub-event is associated with vendor-specific communication).

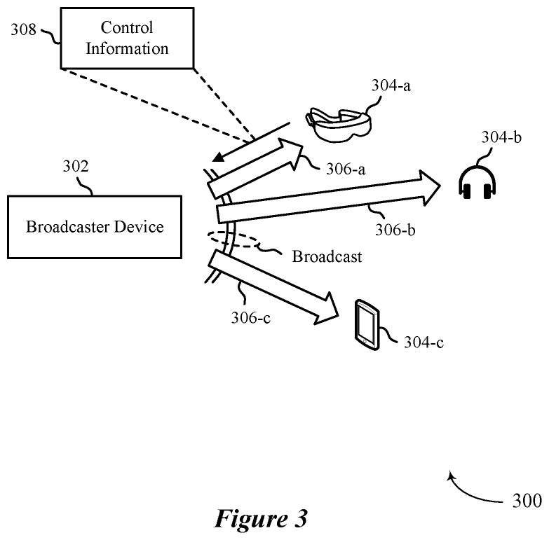

A broadcaster device and one or more peripheral devices may leverage (such as employ) such a signaling mechanism in one or more of various example use cases. Such example use cases may include to enable one or more peripheral devices to provide control feedback to a broadcaster device, to enable a broadcast system to synchronize host-based information between peripheral devices (such as within an in-vehicle media system in which speakers receive media from a car-kit, within a home or office audio system in which a TV applies a user-input volume setting to multiple speakers, or within any other similar systems), and to enable an on-boarding of receivers (peripheral devices) with an initial setting (such as a desired initial volume setting). Generally, the broadcaster device and the one or more peripheral devices may support an LE broadcast control information flow for synchronizing an eco-system. Additional details relating to such example use cases are illustrated by and described with reference to FIGS. 3-5.

FIG. 3 shows an example signaling diagram 300 that supports LE broadcast control information flow for synchronizing a broadcaster device and one or more peripheral devices. The signaling diagram 300 may illustrate an example use case of some of the example implementations disclosed herein. For example, the signaling diagram 300 illustrates broadcast communication from a broadcaster device 302 to a peripheral device 304-a, a peripheral device 304-b, and a peripheral device 304-c via a BIS 306-a, a BIS 306-b, and a BIS 306-c, respectively. A BIG of the broadcaster device 302 may include the BIS 306-a, the BIS 306-b, and the BIS 306-c. While the example signaling diagram 300 includes 3 peripheral devices, the described techniques may be applicable to scenarios of any quantity of peripheral devices.

The broadcaster device 302 may be an example of a STA 104, an AP 102, a STA 204, an AP 202, an intermediate device 212, or a wireless communication device 214, as illustrated by and described with reference to FIGS. 1 and 2. Each of the peripheral device 304-a, the peripheral device 304-b, and the peripheral device 304-c may be an example of a STA 104, an AP 102, a STA 204, an AP 202, an intermediate device 212, or a wireless communication device 214, as illustrated by and described with reference to FIGS. 1 and 2. Generally, the broadcaster device 302, the peripheral device 304-a, the peripheral device 304-b, and the peripheral device 304-c may be examples of any Bluetooth-equipped devices.

In accordance with the signaling diagram 300, the peripheral device 304-a may provide (such as transmit) control information 308 to the broadcaster device 302. Such control information 308 may include feedback (such as control feedback, such as an acknowledgment) or other information associated with the BIG supported by the broadcaster device 302. In other words, in accordance with some example implementations disclosed herein, the broadcaster device 302 may provide a mechanism according to which the broadcaster device 302 may receive control information 308 from a peripheral device. In some examples, the control information 308 may include channel assessment information obtained by the peripheral device 304-a, such as via a channel scan or bad channel assessment performed by the peripheral device 304-a. In such examples, the broadcaster device 302 may use the channel assessment information provided by the peripheral device 304-a to select, determine, or identify a final channel map for broadcasting to the peripheral device 304-a, the peripheral device 304-b, the peripheral device 304-c, or any combination thereof.

In some implementations, the peripheral device 304-a may transmit the control information 308 via a packet, such as a BIG control PDU, during a control sub-event of a BIG event in accordance with an indication that the control sub-event is associated with (such as usable for) vendor-specific information and in accordance with an indication that a direction of transmission for the control sub-event is peripheral-to-broadcaster. In some aspects, the broadcaster device 302 may provide such indications via one or more packets, such as one or more BIS data PDUs, transmitted prior to the control sub-event. For example, the broadcaster device 302 may set a CSTF field bit to 0 and may indicate the direction of transmission via a sequence number field (such as a CSSN field), as illustrated by and described in more detail with reference to FIG. 6.

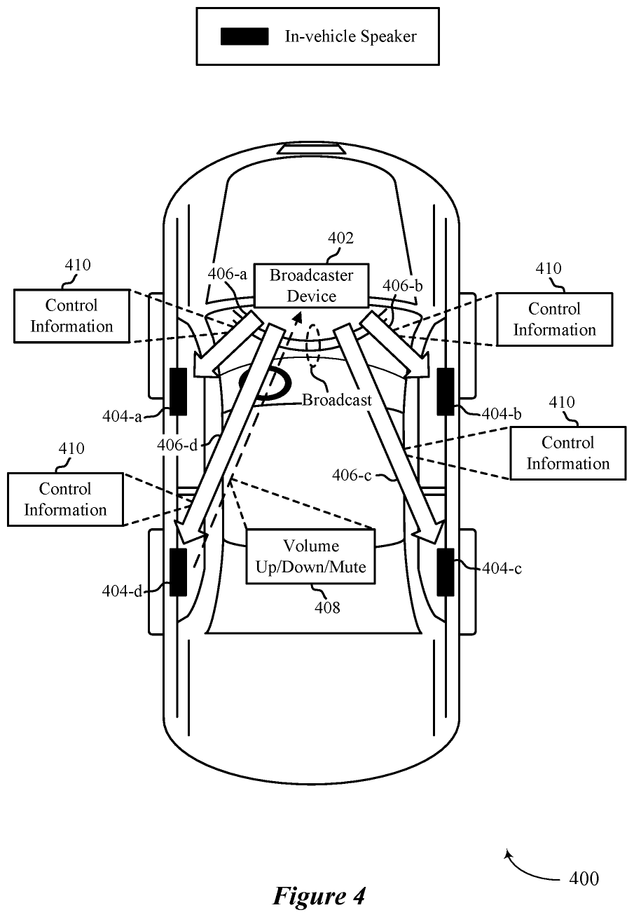

FIG. 4 shows an example signaling diagram 400 that supports LE broadcast control information flow for synchronizing a broadcaster device and one or more peripheral devices. The signaling diagram 400 may illustrate an example use case of some of the example implementations disclosed herein. For example, the signaling diagram 400 illustrates broadcast communication from a broadcaster device 402 to a peripheral device 404-a, a peripheral device 404-b, a peripheral device 404-c, and a peripheral device 404-d via a BIS 406-a, a BIS 406-b, a BIS 406-c, and a BIS 406-d, respectively. A BIG of the broadcaster device 402 may include the BIS 406-a, the BIS 406-b, the BIS 406-c, and the BIS 406-d. While the example signaling diagram 400 includes 4 peripheral devices, the described techniques may be applicable to scenarios of any quantity (such as 7) of peripheral devices.

The broadcaster device 402 may be an example of a STA 104, an AP 102, a STA 204, an AP 202, an intermediate device 212, or a wireless communication device 214, as illustrated by and described with reference to FIGS. 1 and 2. Each of the peripheral device 404-a, the peripheral device 404-b, the peripheral device 404-c, and the peripheral device 404-d may be an example of a STA 104, an AP 102, a STA 204, an AP 202, an intermediate device 212, or a wireless communication device 214, as illustrated by and described with reference to FIGS. 1 and 2. In some deployment scenarios, such as the deployment scenario illustrated in the example signaling diagram 400, the peripheral device 404-a, the peripheral device 404-b, the peripheral device 404-c, and the peripheral device 404-d may be examples of in-vehicle speakers. Additionally, or alternatively, the peripheral device 404-a, the peripheral device 404-b, the peripheral device 404-c, and the peripheral device 404-d may be examples of in-vehicle displays or any other Bluetooth-equipped device within a vehicle. In some deployment scenarios, the broadcaster device 402 may be an example of (or a component of) a car-kit equipped for providing an in-vehicle entertainment or information system or any other Bluetooth-equipped device within a vehicle.

In accordance with the signaling diagram 400, the peripheral device 404-d may provide (such as transmit) a volume up/down/mute indication 408 to the broadcaster device 402. For example, of the multiple peripheral devices (such as speakers) within the vehicle that are receiving media from the car-kit, a passenger in the car proximate to the peripheral device 404-d may receive a call over a cell phone and desire to pause, mute, or reduce the volume of the peripheral device 404-d and all of the other peripheral devices within the vehicle. In such examples, the passenger may press a volume down or pause/mute button on or associated with (such as coupled with) the peripheral device 404-d. Alternatively, the passenger may desire to increase the volume of all the peripheral devices within the vehicle by pressing a volume up button on or associated with (such as coupled with) the peripheral device 404-d. In some aspects, a user interface (UI) of the peripheral device 404-d can provide an option to change the volume of the peripheral device 404-d only (such as the local speaker) or to apply the change to all of (or at least a subset of) the peripheral devices (such as to all of the speakers within the vehicle). Such a subset of peripheral devices may include the peripheral devices nearest to the passenger (and, likewise, nearest to the peripheral device 404-d).

When the passenger selects to change the volume of all of (or at least multiple of) the peripheral devices, the peripheral device 404-d may transmit the volume up/down/mute indication 408 to the broadcaster device 402. In some implementations, the peripheral device 404-d may transmit the volume up/down/mute indication 408 via a packet (such as a BIG control PDU) during a control sub-event. In such implementations, the peripheral device 404-d may transmit the volume up/down/mute indication 408 via the packet in accordance with an indication that the control sub-event is associated with vendor-specific information and an indication that the control sub-event is associated with a direction of transmission of peripheral-to-broadcaster.

In accordance with the broadcaster device 402 receiving the volume up/down/mute indication 408 (via a control sub-event or via some other signaling mechanism) from the peripheral device 404-d, the broadcaster device 402 may apply the indicated control setting (provided by the volume up/down/mute indication 408) to one or more other peripheral devices within the vehicle (such as to all (other) peripheral devices within the vehicle). In some implementations, the broadcaster device 402 may transmit control information 410 indicating the control setting to the peripheral devices during a control sub-event. In such implementations, the broadcaster device 402 may transmit the control information 410 via a packet (such as a BIG control PDU) during the control sub-event in accordance with an indication that the control sub-event is associated with vendor-specific information and an indication that the control sub-event is associated with a direction of transmission of broadcaster-to-peripheral.

In some aspects, the broadcaster device 402 may provide such indications of how an upcoming control sub-event is to be used via one or more packets, such as one or more BIS data PDUs, transmitted prior to the upcoming control sub-event. For example, the broadcaster device 402 may set a CSTF field bit to 0 and may indicate the direction of transmission via a sequence number field (such as a CSSN field), as illustrated by and described in more detail with reference to FIG. 6. In accordance with the signaling diagram 400, the broadcaster device 402 may synchronize host-based (control) information between peripheral devices.

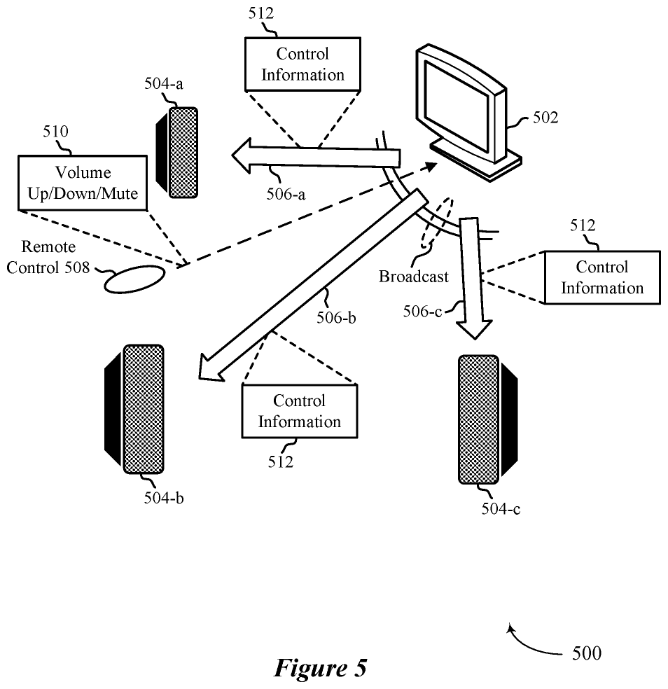

FIG. 5 shows an example signaling diagram 500 that supports LE broadcast control information flow for synchronizing a broadcaster device and one or more peripheral devices. The signaling diagram 500 may illustrate an example use case of some of the example implementations disclosed herein. For example, the signaling diagram 500 illustrates broadcast communication from a broadcaster device 502 to a peripheral device 504-a, a peripheral device 504-b, and a peripheral device 504-c via a BIS 506-a, a BIS 506-b, and a BIS 506-c, respectively. A BIG of the broadcaster device 502 may include the BIS 506-a, the BIS 506-b, and the BIS 506-c. While the example signaling diagram 500 includes 3 peripheral devices, the described techniques may be applicable to scenarios of any quantity of peripheral devices.

The broadcaster device 502 may be an example of a STA 104, an AP 102, a STA 204, an AP 202, an intermediate device 212, or a wireless communication device 214, as illustrated by and described with reference to FIGS. 1 and 2. Each of the peripheral device 504-a, the peripheral device 504-b, and the peripheral device 504-c may be an example of a STA 104, an AP 102, a STA 204, an AP 202, an intermediate device 212, or a wireless communication device 214, as illustrated by and described with reference to FIGS. 1 and 2. In some deployment scenarios, the broadcaster device 502 may be an example of a TV broadcasting (LE) ISO data and the peripheral device 504-a, the peripheral device 504-b, and the peripheral device 504-c may be examples of speakers (such as in-house speakers of, for example, a home theater). Generally, the broadcaster device 502, the peripheral device 504-a, the peripheral device 504-b, and the peripheral device 504-c may be examples of any Bluetooth-equipped devices.

In accordance with the signaling diagram 500, the broadcaster device 502 may be broadcasting to the peripheral device 504-a, the peripheral device 504-b, and the peripheral device 504-c and a user may press a volume up, down, or mute button using a remote control 508 (such as a TV remote control). In accordance with receiving a volume up/down/mute indication 510 from the remote control 508, the broadcaster device 502 may transmit control information 512 to the peripheral devices to apply the indicated setting to all, or at least a subset, of the peripheral devices (such as to all of the in-house speakers). In some implementations, the broadcaster device 502 may transmit the control information 512 via a packet (such as a BIG control PDU) during a control sub-event. The broadcaster device 502 may transmit the control information 512 via the packet during the control sub-event in accordance with an indication that the control sub-event is associated with vendor-specific information and an indication that the control sub-event is associated with a direction of transmission of broadcaster-to-peripheral.

Additionally, or alternatively, the broadcaster device 502 may leverage aspects of the signaling diagram 500 to on-board one or more receivers (one or more of the peripheral device 504-a, the peripheral device 504-b, and the peripheral device 504-c) with an initial setting (such as a desired initial setting, such as a desired initial volume setting). For example, if a user has changed a setting (such as the volume) and if the peripheral device 504-a, the peripheral device 504-b, and the peripheral device 504-c are operating at some non-default setting (such as some non-default volume) in accordance with the changed setting, and if at least one of the peripheral device 504-a, the peripheral device 504-b, and the peripheral device 504-c loses synchronization with the broadcaster device 502 and subsequently re-synchronizes, the broadcaster device 502 may provide control information 512 to inform the re-synchronized peripheral device(s) to start with the changed setting (such as the set level of the volume as previously changed by the user).

In some implementations, the broadcaster device 502 may provide such control information 512 via a packet (such as a BIG control PDU) during a control sub-event in accordance with an indication that the control sub-event is associated with vendor-specific information and an indication that the control sub-event is associated with a direction of transmission of broadcaster-to-peripheral. For example, to avoid a re-synchronized peripheral device from starting with a default value (when a non-default value is now used in accordance with a user command) such that the user may have to again press a volume up/down/mute button to set the same (volume) level for a set of peripherals (at which point the broadcaster device 502 may send an indication of an absolute volume level rather than an increase or decrease to synchronize the set of peripheral devices to a same level), the broadcaster device 502 may send on-boarding information (such as essential on-boarding information, such as a volume level setting) periodically via a control sub-event. Thus, the broadcaster device 502 may leverage use of a control sub-event associated with vendor-specific information to avoid an intervention by the user, which may improve a user experience. The broadcaster device 502 may periodically transmit such on-boarding information at any time interval, such as approximately every one-half second, approximately every 1 second, or approximately every 2 seconds, among other options.

In some aspects, the broadcaster device 502 may provide such indications of how an upcoming control sub-event is to be used via one or more packets, such as one or more BIS data PDUs, transmitted prior to the upcoming control sub-event. For example, the broadcaster device 502 may set a CSTF field bit to 0 and may indicate the direction of transmission via a sequence number field (such as a CSSN field), as illustrated by and described in more detail with reference to FIG. 6. In accordance with the signaling diagram 500, the broadcaster device 502 may synchronize host-based (control) information between peripheral devices.

FIG. 6 shows an example communication timeline 600 that supports LE broadcast control information flow for synchronizing a broadcaster device and one or more peripheral devices. The communication timeline 600 may implement or be implemented to realize aspects of the wireless communication network 100, the wireless communication network 200, the signaling diagram 300, the signaling diagram 400, or the signaling diagram 500. For example, a broadcaster device and one or more peripheral devices may communicate in accordance with the communication timeline 600, and such a broadcaster device and such peripheral device(s) may be examples of corresponding devices as illustrated and described herein, including by and with reference to FIGS. 1-5.

The communication timeline 600 includes a BIG event 602 and, within the BIG event 602, a BIS event 604. Generally, although only a single BIS event 604 is illustrated in the example of FIG. 6, the BIG event 602 may include multiple BIS events 604, different BIS events 604 corresponding to or otherwise associated with different BISs of a BIG associated with the BIG event 602. For example, a first BIS event 604 of the BIG event 602 may be associated with a first BIS and a second BIS event 604 of the BIG event 602 may be associated with a second BIS. The first BIS event 604 and the second BIS event 604 may be overlapping in time, partially overlapping in time, or not overlapping in time. The BIG event 602 may be associated with a set of sub-events, each sub-event of the BIG event 602 corresponding to or associated with a BIS event 604. In some examples, the BIG event 602 and the BIS event 604 may both start at a BIG anchor point. The BIS event 604 may include a number of sub-events including a sub-event 606-a, a sub-event 606-b, and a sub-event 606-c. The BIG event 602 may optionally additionally include a control sub-event 606-d. In some implementations, the control sub-event 606-d may be present regardless of whether a specification-defined BIG control PDU is scheduled for transmission during the control sub-event 606-d. Instead, the control sub-event 606-d may be present in accordance with other criteria (such as in accordance with CSSN not being set to a specific, default value or pattern, such as a bit pattern of all zeros, which may indicate an absence of the control sub-event 606-d) and, when present, may be usable for either a specification-defined purpose or for vendor-specific communication in accordance with a signaled indication. The control sub-event 606-d may be present after a last BIS event 604 of the BIG event 602.

For example, the broadcaster device may transmit a packet 608-a (a first BIS data PDU) during the sub-event 606-a, a packet 608-b (a second BIS data PDU) during the sub-event 606-b, and a packet 608-c (a third BIS data PDU) during the sub-event 606-c and at least one (in some examples, each) of the packet 608-a, the packet 608-b, and the packet 608-c may indicate whether the control sub-event 606-d is associated with vendor-specific communication. In some implementations, a packet may indicate whether the control sub-event 606-d is associated with vendor-specific communication in accordance with a setting of a CSTF field 610 of the packet. For example, if the CSTF field 610 is set such that CSTF=1, the control sub-event 606-d may be interpreted or otherwise expected (by the broadcaster device and the peripheral device(s)) to be associated with a specification-defined purpose. If the CSTF field 610 is set such that CSTF=0, the control sub-event 606-d may be interpreted or otherwise expected (by the broadcaster device and the peripheral device(s)) to be associated with vendor-specific communication (such as communication of proprietary information or for a proprietary purpose).

In implementations in which the CSTF bit is set to a zero value (such that CSTF=0), a broadcaster device may use a sequence number field 612 (which may be an example of a CSSN field) to indicate or otherwise convey (to the peripheral device(s)) a purpose of the control sub-event 606-d. In some aspects, to facilitate use of the sequence number field 612 as being indicative of a purpose of the control sub-event 606-d, the broadcaster device and the peripheral device(s) may divide (such as split) the sequence number field 612 into multiple (such as 2) parts. A first part of the sequence number field 612 may precede a second part of the sequence number field 612, or vice versa. For example, the first part may correspond to an initial set of one or more bits of the sequence number field 612 and the second part may correspond to a subsequent (such as an immediately subsequent) set of one or more bits of the sequence number field 612, or vice versa.

In some implementations, the first part of the sequence number field 612 may define (such as indicate) a direction of transmission 614 (such as an information flow direction). In other words, the first part may indicate whether the information flow direction during the control sub-event 606-d is broadcaster-to-peripheral or peripheral-to-broadcaster. Thus, the direction of transmission 614 may correspond to or indicate broadcaster-to-peripheral or peripheral-to-broadcaster. In some aspects, the first part of the sequence number field 612 may be 1 bit in size. In some examples, a first bit value (such as a bit value of 0) of the single bit may indicate that the control sub-event 606-d is used for broadcaster-to-peripheral information and a second bit value (such as a bit value of 1) of the single bit may indicate that the control sub-event 606-d is used for peripheral-to-broadcaster information.

In some implementations, the second part of the sequence number field 612 may define (such as indicate) a sequence number 616. In some examples, the second part may indicate a sequence number 616 that is valid when the information flow (the direction of transmission 614) is from broadcaster-to-peripheral, which may enable a peripheral device to avoid receiving and decoding repeated information from the broadcaster device. When the information flow is from peripheral-to-broadcaster, the peripheral devices may ignore the second part of the sequence number field 612. In some aspects, the second part of the sequence number field 612 that indicates the sequence number 616 may be 2 bits in size.

Additionally, or alternatively, the second part may indicate a sequence number 616 that is valid when the information flow (the direction of transmission 614) is from peripheral-to-broadcaster, which may enable a peripheral device to indicate a sequence number 616 of a particular feedback so that the broadcaster device refrains from acting on the feedback repeatedly (such that the broadcaster refrains from updating one or more communication parameters multiple times based on the same feedback information). For example, a peripheral device may use the sequence number field 612 within a BIG control PDU sent during a control sub-event (such as the control sub-event 606-d) to indicate a sequence number 616 associated with control information transmitted by the peripheral device via the BIG control PDU. In other words, the control PDUs (BIG control PDUs) from a peripheral device to a broadcast device may set CSSN such that the broadcaster device can identify the retransmissions. A peripheral device may transmit a same control PDU for a configurable quantity of times. In some implementations, the broadcaster device may transmit configuration information (such as via PA) indicative of the configurable quantity of times that a peripheral device can transmit a same control PDU.

Additionally, or alternatively, the sequence number field 612 may indicate that the direction of transmission 614 is broadcaster-to-peripheral or peripheral-to-broadcaster in accordance with a bit pattern of the sequence number field 612, among other information related to the use purpose of the control sub-event 606-d. For example, a first bit pattern of the sequence number field 612 (such as a bit pattern of ‘000’) may indicate that the control sub-event 606-d will not be used by the broadcaster device or a peripheral device. For further example, a second bit pattern of the sequence number field 612 (such as a bit pattern of ‘001’) may indicate that the control sub-event 606-d is associated with a direction of transmission 614 of peripheral-to-broadcaster. For further example, a third bit pattern of the sequence number field 612 (such as a bit pattern of ‘010’) may indicate that the control sub-event 606-d is associated with a direction of transmission 614 of broadcaster-to-peripheral. Other bit patterns of the sequence number field 612 may be reserved or may be used for conveying additional information associated with a use purpose of the control sub-event 606-d.

In some examples, a reserved value of CSSN may indicate that a broadcaster device will have more than one control sub-event. In some implementations, all of such two or more control sub-events may be used for a broadcaster-to-peripheral transmission direction. In some other implementations, an initial control sub-event of such two or more control sub-events may be used for a broadcaster-to-peripheral transmission direction, and the rest of such two or more control sub-events may be used by one or more peripherals to transmit to the broadcaster device. Generally, various meanings may be associated with a particular bit pattern of the CSSN. Such meanings, and their associations with a respective bit pattern of the CSSN, may be signaled by the broadcaster device via control information associated with the BIG.

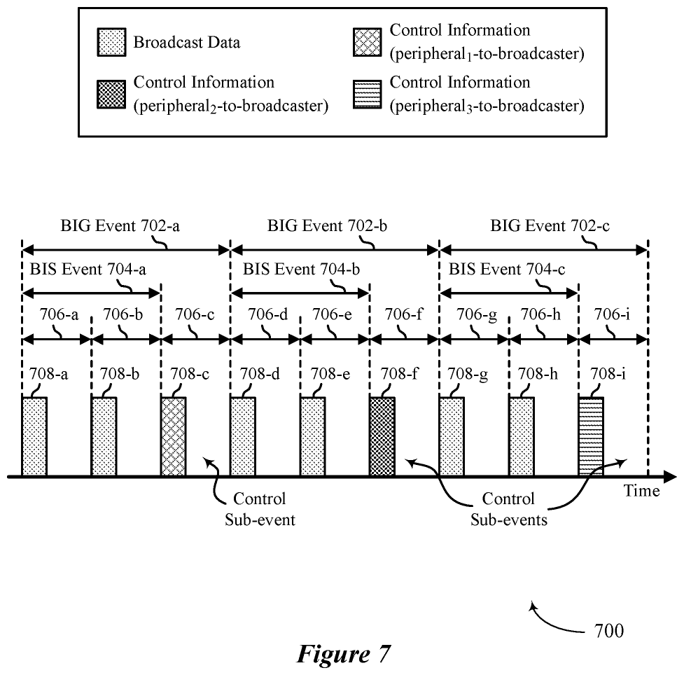

In accordance with the CSTF field 610 being set such that CSTF=0 and in accordance with the indicated direction of transmission 614, the broadcaster device or a peripheral device may transmit a packet 608-d (such as a BIG control PDU) during the control sub-event 606-d. For example, if the indicated direction of transmission 614 is broadcaster-to-peripheral, the broadcaster device may transmit the packet 608-d including control information (such as vendor-specific or proprietary information) and the peripheral device(s) may monitor for the packet 608-d during the control sub-event 606-d. Alternatively, if the indicated direction of transmission 614 is peripheral-to-broadcaster, a peripheral device may transmit the packet 608-d including control information (such as feedback information or vendor-specific or proprietary information) and the broadcaster device may monitor for the packet 608-d during the control sub-event 606-d. Additional details relating to which peripheral device, of potentially multiple peripheral devices, may transmit during the control sub-event 606-d of the BIG event 602 are illustrated by and described with reference to FIG. 7.

A device transmitting the packet 608-d may generate the control information transmitted via the packet 608-d at a host of the transmitting device or at a controller of the transmitting device and, in accordance with the described techniques, flows from a receiver (a peripheral) to the broadcaster or from the broadcaster to the receiver(s). Thus, the communication timeline 600 illustrates a signaling mechanism for control information flow amongst a broadcaster and one or more broadcast receivers in LE ISO. There may be multiple different types of information that can be sent or received using the control sub-event 606-d and, in some implementations, the packet 608-d inside the control sub-event 606-d may leverage the BIG control PDU structure, according to which a type of the PDU is given in (such as indicated by) an opcode field of the packet 608-d. In implementations in which CSTF=0, the opcode field of the packet 608-d may be 1 octet long or may be 2 octets long. An example BIG control PDU payload structure is illustrated in Table 1, shown below.

TABLE 1
Example BIG Control PDU Payload Format
Payload

| Opcode | Control Data |
|---|---|
| (1 or 2 octets) | (0 to 250 octets) |

For further example, another example BIG control PDU payload structure is illustrated in Table 2, shown below. Generally, there may be multiple formats of a vendor-specific control packet. As illustrated in the example BIG control PDU payload structure illustrated in Table 2, the format may indicate that there is an initial set of fixed information (such as one or more of Opcode, company identifier (ID), or product ID) followed by actual control information. In an example, the Opcode may occupy bits 0-7, the company ID may occupy bits 8-23, and the product ID may occupy bits 24-39. One BIG control PDU may include one or multiple instances of control information. Each instance of control information may include a subopcode (such as a code that specifies or indicates what the corresponding control information is about, such as a type, source, or purpose of the control information), an indication of a length of that instance of control information, and the control information data. In an example, a first subopcode may occupy bits 40-47 (or, generally, a set of 8 bits), a first length indication may occupy bits 48-55 (or, generally, a set of 8 bits), and a first instance of control information data may occupy a set of bits as indicated by the first length indication (such as a first quantity of octets).

TABLE 2
Example BIG Control PDU Payload Format
Payload

| | | | | | |
|---|---|---|---|---|---|
| Opcode | Company ID | Product ID | Subopcode 1 | Length 1 | Control Data 1 |
| | | . . . | Subopcode 2 | Length 2 | Control Data 2 |

Each subopcode may correspond to a different use purpose associated with the control data (such as the control information), where different subopcodes may correspond to different use purposes. Further, different subopcodes may correspond to different transmission directions. Some example use purposes may include a ping timeout indication, a power control indication, a skip indication, a device type indication, a channel classification indication, an RSSI indication, a power control request, a PA parameters request, a reception status indication, a ping indication, an address indication, a pre-transmission offset (PTO) request, a PTO indication, or a PTO timeout indication, among other examples. In some examples, a subopcode or a format associated with the control information may indicate whether the control information (vendor-specific information) is specific for a particular BIS (or for a particular set of BISs) or is applicable to all BISs of the BIG.

The control data of the payload may be equivalently referred to herein as control information. In some implementations, a device transmitting the packet 608-d may concatenate multiple control information (such as multiple control information types) in a single control sub-event (such as the control sub-event 606-d) using an (Opcode, Length, Data) format in examples in which length can be variable or an (Opcode, Data) format otherwise.

Some example information types may include controller-based information and host-based information. Controller-based information may include, for example, channel assessment information (such that controller-based information may be used when a peripheral device intends to send its channel assessment information). Host-based information may include information indicative of, for example, a user setting (such as volume up/down/mute). In some implementations, the device transmitting the packet 608-d may use the opcode of the packet 608-d to indicate the information type (such that some, if not all, information types are defined using opcode). In other words, each permutation of bits of an opcode (or any other set of bits, such as any other set of 8 bits) of a BIG control PDU may correspond to a respective information type (an information type being channel assessment information, power information, volume information, or the like).

For host-based information, a device may leverage the vendor-specific command (which also may be referred to herein as a VS command) and event (such as HCI VS LE BIS CTRL INFO). The device also may concatenate multiple control information into a single VS command using an (Opcode, Length, Data) format in examples in which length can be variable or an (Opcode, Data) format otherwise. In some implementations, a source of the host-based information may use a vendor-specific command to provide the control information to the controller (of the device transmitting the packet 608-d) and the control information may be passed on to the other side host using the vendor-specific event (such as the control sub-event 606-d).

In some implementations, the device transmitting the packet 608-d may use a most significant bit (MSB) or any other bit of the opcode to differentiate between host-based information and controller-based information. In such implementations, a device receiving the packet 608-d may more easily differentiate between host-based information and controller-based information, which may save some processing at the controller of the receiving device. In some examples, an opcode MSB of a first bit value (such as 0) may indicate controller-based information and an opcode MSB of a second bit value (such as 1) may indicate host-based information. An example of such a use of the MSB of the opcode is illustrated by Table 3, shown below.

TABLE 3
Opcode MSB Use to Indicate Host-vs. Controller-based Information

| Opcode MSB | Opcode Excluding MSB |
|---|---|
| Information Source Bit: | Information Type |
| 0 = Host-based information | |
| 1 = Controller-based information | |

An example of an opcode table associated with the packet 608-d in implementations in which the packet 608-d carries controller-based information (such as link related information, such as channel assessment information or power information) is illustrated by Table 4, shown below. The information provided via such an opcode as illustrated by Table 4 is for purpose of example, and any of such information may not be provided, or other additional information not shown may be provided, without exceeding the scope of the present disclosure.

TABLE 4
Opcode Table for Controller-based Information

| Opcode | Opcode excluding | Information Length | Information |
|---|---|---|---|
| MSB | MSB | (Octets) | Description |
| 0 | 0 x 0 | 10 (79 bits are | Channel Assessment |
| | | meaningful) | |

An example of an opcode table associated with the packet 608-d in implementations in which the packet 608-d carries host-based information is illustrated by Table 5, shown below. The information provided via such an opcode as illustrated by Table 5 is for purpose of example, and any of such information may not be provided, or other additional information not shown may be provided, without exceeding the scope of the present disclosure.

TABLE 5
Opcode Table for Host-based Information

| | Opcode | Information | |
|---|---|---|---|
| Opcode | excluding | Length | Information |
| MSB | MSB | (Octets) | Description |
| 1 | 0x00 | 1 | Volume Level |
| 1 | 0x01 | 0 | Mute |
| 1 | 0x02 | — | Speaker's light control |
| | | | Information |

FIG. 7 shows an example communication timeline 700 that supports LE broadcast control information flow for synchronizing a broadcaster device and one or more peripheral devices. The communication timeline 700 may implement or be implemented to realize aspects of the wireless communication network 100, the wireless communication network 200, the signaling diagram 300, the signaling diagram 400, the signaling diagram 500, or the communication timeline 600. For example, a broadcaster device and multiple peripheral devices may communicate in accordance with the communication timeline 700, and such a broadcaster device and such peripheral devices may be examples of corresponding devices as illustrated and described herein, including by and with reference to FIGS. 1-6.

The communication timeline 700 includes a BIG event 702-a, a BIG event 702-b, and a BIG event 702-c. The BIG event 702-a may include a BIS event 704-a of one or multiple sub-events, the BIG event 702-b may include a BIS event 704-b of one or multiple sub-events, and the BIG event 702-c may include a BIS event 704-c of one or multiple sub-events. Generally, the BIG event 702-a, the BIG event 702-b, and the BIG event 702-c may include one or multiple BIS events, each BIS event corresponding to or associated with a different BIS of the BIG. For example, the BIS event 704-a may include a sub-event 706-a and a sub-event 706-b, the BIS event 704-b may include a sub-event 706-d and a sub-event 706-e, and the BIS event 704-c may include a sub-event 706-g and a sub-event 706-h. The BIG event 702-a may further include a control sub-event 706-c, the BIG event 702-b may further include a control sub-event 706-f, and the BIG event 702-c may further include a control sub-event 706-i.

As illustrated in the example of the communication timeline 700, a broadcaster device may communicate with at least 3 peripheral devices including a first peripheral device (denoted as peripheral₁ in the example of FIG. 7), a second peripheral device (denoted peripheral₂ in the example of FIG. 7), and a third peripheral device (denoted peripheral₃ in the example of FIG. 7). However, the techniques described with reference to FIG. 7 may be applicable to scenarios associated with any quantity of two or more peripheral devices.

In some implementations, the broadcaster device and the peripheral devices may support a clash avoidance scheme according to which multiple peripheral devices may avoid transmitting via a same control sub-event (if the control sub-event is associated with vendor-specific communication and a direction of transmission of peripheral-to-broadcaster). In some examples, the peripheral devices may avoid clashes in accordance with a rule or calculation (generally, a criteria) that indicates when a peripheral device is allowed to transmit via a control sub-event. For example, such a criteria may be such that a peripheral device associated with a BIS index (such as a BIS number) n may transmit during a BIG event in accordance with a BIG event number associated with that BIG event. For example, if “BIG event number” mod “total quantity of BISs”=n−1, the peripheral device may transmit during a control sub-event of that BIG event (if that control sub-event is associated with vendor-specific communication and a direction of transmission of peripheral-to-broadcaster). As used herein, “mod” may refer to a modulo operation between two numbers, such that “X mod Y” may be equivalently referred to as a modulo operation between X and Y. Satisfaction of “BIG event number” mod “total quantity of BISs”=n−1 may be understood as a satisfaction of a criteria (such as a transmission criteria) for the peripheral device tuned to BIS index n. By way of another example, if there are two BISs, a peripheral device tuned to a first BIS may transmit during control sub-events of even-numbered BIG events and a peripheral device tuned to a second BIS may transmit during control sub-events of odd-numbered BIG events.

Thus, in examples in which the first peripheral device is associated with a first BIS, the second peripheral device is associated with a second BIS different from the first BIS, and the third peripheral device is associated with a third BIS different from the first BIS and the second BIS, each of the three peripheral devices may transmit during control sub-events of different BIG events. For example, the first peripheral device may transmit a packet 708-c (such as a first BIG control PDU) during the control sub-event 706-c of the BIG event 702-a, the second peripheral device may transmit a packet 708-f (such as a second BIG control PDU) during the control sub-event 706-f of the BIG event 702-b, and the third peripheral device may transmit a packet 708-i (such as a third BIG control PDU) during the control sub-event 706-i of the BIG event 702-c. In other words, if the first BIS to which the first peripheral device is tuned is associated with a first BIS index n₁, the “BIG event number” of the BIG event 702-a mod “total quantity of BISs”=n₁−1. Similarly, if the second BIS to which the second peripheral device is tuned is associated with a second BIS index n₂, the “BIG event number” of the BIG event 702-b mod “total quantity of BISs”=n₂−1. Further, if the third BIS to which the third peripheral device is tuned is associated with a third BIS index n₃, the “BIG event number” of the BIG event 702-c mod “total quantity of BISs”=n₃−1.

In some aspects, the first peripheral device may transmit the packet 708-c during the control sub-event 706-c in accordance with at least one of a packet 708-a or a packet 708-b (such as at least one of the BIS data PDUs sent during the BIG event 702-a) indicating that the control sub-event 706-c is associated with vendor-specific communication from peripheral-to-broadcaster. Similarly, the second peripheral device may transmit the packet 708-f during the control sub-event 706-f in accordance with at least one of a packet 708-d or a packet 708-e (such as at least one of the BIS data PDUs sent during the BIG event 702-b) indicating that the control sub-event 706-f is associated with vendor-specific communication from peripheral-to-broadcaster. Further, the third peripheral device may transmit the packet 708-i during the control sub-event 706-i in accordance with at least one of a packet 708-g or a packet 708-h (such as at least one of the BIS data PDUs sent during the BIG event 702-c) indicating that the control sub-event 706-i is associated with vendor-specific communication from peripheral-to-broadcaster.

In some deployment scenarios, there may be two or more peripheral devices that are tuned to a same BIS and, therefore, a same BIS index (the same BIS number) n. In such scenarios, the two or more peripheral devices that are tuned to the same BIS may attempt to transmit a control PDU (a BIG control PDU) during a same BIG event (in accordance with a rule or calculation associated with “BIG event number” mod “number of BISs”=n−1). In some implementations, to resolve such a possibility for collision, a peripheral device may, when (re) transmitting a control PDU, select a random back-off (RBO) in terms of a quantity of BIG events. In such implementations, any two or more peripheral devices that happened to transmit a control PDU during a same control sub-event may have a relatively-low likelihood of performing retransmissions of their respective control PDUs during a same control sub-event, which may increase the reliability of peripheral-to-broadcaster control information flow. For example, a first peripheral device and a second peripheral device may initially transmit a first control PDU and a second control PDU, respectively, during a same control sub-event and, in accordance with a separate RBO selection for retransmissions of their respective control PDUs, will likely transmit second instances of the first control PDU and the second control PDU, respectively, during different control sub-events (due to a likelihood of the two peripheral devices selecting different RBOs).

In some aspects, a peripheral device may select an RBO within a range of RBOs, such as a range from 0-10, or a range from 0-15, or a range from 0-20. In some aspects, the range of available RBOs may be correlated with a quantity of peripheral devices (potentially) tuned to a same BIS. For example, a first range of RBOs (such as 0-10) may be available if a first quantity of peripheral devices are tuned to a same BIS and a second range of RBOs (such as 0-50) greater than the first range of RBOs may be available if a second quantity of peripheral devices greater than the first quantity of peripheral devices are tuned to a same BIS.

In some implementations, the broadcaster device and the peripheral audio devices may additionally, or alternatively, support a power conservation scheme to conserve power, which may be especially useful for non-main powered (such as battery-powered) broadcaster devices (such as a cell phone). In accordance with an example power conservation scheme, the broadcaster device may selectively monitor control sub-events that are associated with vendor-specific communication (CSTF=0) (and a direction of transmission of peripheral-to-broadcaster). For example, the broadcaster device may monitor (such as listen) for vendor-specific communication during control sub-events of BIG events that are a multiple of a configured number (such as 1, 2, 3, or 4, among other options) and may refrain from monitoring control sub-events otherwise. In some implementations, the broadcaster device may transmit, to the peripheral devices, an indication of the multiple via configuration information (such as via PA) associated with the BIG. Such a multiple may be referred to herein as a BIG event number multiple. Correspondingly, a peripheral device may mark an individual BIG event during which the peripheral device is able to (such as allowed to) transmit control information based on (such as in view of or otherwise in accordance with) the configured multiple.

Generally, a peripheral device may transmit when (“BIG event number” mod “BIG event number multiple”=0, direction bit=1 (indicating a peripheral-to-broadcaster information flow), and CSTF=0. Satisfaction of “BIG event number” mod “BIG event number multiple”=0 may be understood as a satisfaction of a criteria (such as a transmission criteria) for a peripheral device. If the BIG event number multiple is set equal to, for example, 4, the broadcaster device may listen on (such as monitor) control sub-events of BIG events that are multiples of 4 and when the direction bit (a first part of a sequence number field) is set to indicate a direction of transmission of peripheral-to-broadcaster. Otherwise, the broadcaster device may refrain from monitoring control sub-events for vendor-specific information from a peripheral device. Likewise, a peripheral device may transmit control information via a control sub-event when (“BIG event number” mod “4”=0, direction bit=1, and CSTF=0. Otherwise, the peripheral device may refrain from transmitting control information via a control sub-event.

In examples in which the broadcaster device and the peripheral devices support both power conservation and clash avoidance, a peripheral device tuned to a BIS index n may transmit when “BIG event number” divided by “BIG event number multiple”={n+(x*“total quantity of BISs”)}, where x={0, 1, 2, 3, . . . }. Satisfaction of “BIG event number” divided by “BIG event number multiple”={n+(x*“total quantity of BISs”)}, where x={0, 1, 2, 3, . . . } may be understood as a satisfaction of a criteria (such as a transmission criteria) for a peripheral device tuned to BIS index n. For example, if the broadcaster device is broadcasting three channels (including the first BIS, the second BIS, and the third BIS, such that the total quantity of BISs is equal to 3) and if the BIG event number multiple is set equal to 4, the first peripheral device tuned to the first BIS of index n₁=1 may transmit control information when “BIG event number” divided by “4”=1, 4, 7, . . . (which may correspond to BIG event numbers 4, 16, 28, . . . ). For further example, the second peripheral device tuned to the second BIS of index n₂=2 may transmit control information when “BIG event number” divided by “4”=2, 5, 8, . . . (which may correspond to BIG event numbers 8, 20, 32, . . . ) and the third peripheral device tuned to the third BIS of index n₃=3 may transmit control information when “BIG event number” divided by “4”=3, 6, 9, . . . (which may correspond to BIG event numbers (12, 24, 36, . . . ).

In some implementations, a peripheral device may (re) transmit using an RBO, in terms of a quantity of BIG events, to increase the reliability of peripheral-to-broadcaster information flow in scenarios in which multiple peripheral devices may be tuned to a same BIS. A peripheral device may start an RBO counter from the BIG event during which the peripheral device initially transmits control information (in accordance with a criteria for transmission being satisfied) or from which the peripheral device satisfied a criteria to be able to transmit control information (if the peripheral device refrains from transmitting during that BIG event and instead waits to perform an initial transmission once the RBO counter gets to zero).

In accordance with selecting an RBO for a (re) transmission of control information via a control sub-event, a peripheral device may count a quantity of BIG events equal to the selected RBO and selectively transmit the control information via a control sub-event of a BIG event at which the counted quantity of BIG events is equal to the selected RBO. In some implementations, the peripheral device may count BIG events that include control sub-events via associated with a peripheral-to-broadcaster information flow and refrain from counting other BIG events (such that BIG events that include control sub-events associated with a broadcaster-to-peripheral information flow do not decrement an RBO counter or are otherwise not counted toward the RBO). In some other implementations, the peripheral device may count BIG events that include control sub-events associated with a peripheral-to-broadcaster information flow and that satisfy the criteria for the peripheral device and may refrain from counting other BIG events. In some other implementations, the peripheral device may count all BIG events regardless of whether the BIG event is associated with a peripheral-to-broadcaster information flow or a broadcaster-to-peripheral information flow. Once an RBO counter reaches zero, a peripheral device may transmit during the control sub-event of the BIG event at which the RBO counter reached zero or during the control sub-event of the next BIG event for which a criteria for the peripheral device is satisfied (if the criteria is not satisfied for the BIG event at which the RBO counter reached zero).

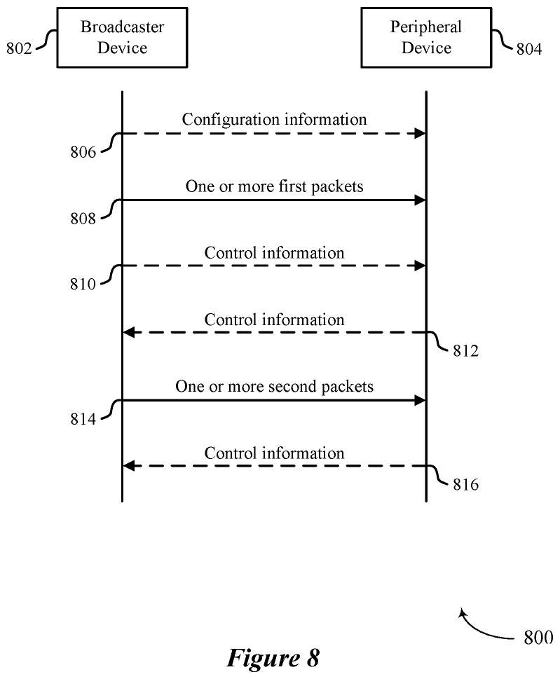

FIG. 8 shows an example process flow 800 that supports LE broadcast control information flow for synchronizing a broadcaster device and one or more peripheral devices. The process flow 800 may implement or be implemented to realize aspects of the wireless communication network 100, the wireless communication network 200, the signaling diagram 300, the signaling diagram 400, the signaling diagram 500, the communication timeline 600, or the communication timeline 700. For example, the process flow 800 illustrates communication between a broadcaster device 802 and a peripheral device 804, which may be examples of corresponding devices as illustrated and described herein, including by and with reference to FIGS. 1-7.

In the following description of process flow 800, the operations between the broadcaster device 802 and the peripheral device 804 may be performed in a different order than the order shown, or other operations may be added or removed from the process flow 800. For example, some operations also may be left out of process flow 800, or may be performed in different orders or at different times. Further, although some operations or signaling may be shown to occur at different times for discussion purposes, these operations may actually occur at the same time. Although the broadcaster device 802 and the peripheral device 804 are shown performing the operations of process flow 800, some aspects of some operations also may be performed by one or more other wireless communication devices.

At 806, the broadcaster device 802 may transmit configuration information associated with a BIG to one or more peripheral devices including the peripheral device 804. The configuration information may be indicative of one or more parameters associated with establishing, maintaining, operating on, or communicating via the BIG (and of one or more BISs of the BIG). In some implementations, the configuration information may include an indication of a mapping between BIS indices and BIG events. Such a mapping may be indicative of a criteria (such as a rule or calculation) according to which a BIS index maps to a BIG event or may be indicative of a mapping or correspondence table between BIS indices and BIG events. A peripheral device (such as the peripheral device 804) tuned to (such as associated with) a first BIS index may potentially transmit control information via a control sub-event of a first BIG event if the BIS index maps to the first BIG event in accordance with the mapping. Additionally, or alternatively, the configuration information may include an indication of a BIG event number multiple associated with vendor-specific communication. The BIG event number multiple may be associated with a power conservation scheme and may contribute to (such as limit or make stricter) a criteria according to which a peripheral device (such as the peripheral device 804) is able to transmit via a control sub-event of a given BIG event. In some examples, the broadcaster device 802 may transmit the configuration information via PA.

At 808, the broadcaster device may transmit, during one or more sub-events of a first BIG event, one or more first packets via the one or more BISs of the BIG. In some examples, the one or more first packets may be examples of BIS data packets transmitted via one or more (such as all) BIS events associated with the one or more (such as all) BISs of the BIG. In some implementations, at least one of (and, in some examples, each or all of) the one or more first packets may indicate that a control sub-event of the first BIG event is associated with (such as usable for) vendor-specific communication. For example, a CSTF field of at least one of the one or more first packets may be set to a bit value that indicates, to the peripheral device 804, that the control sub-event of the first BIG is associated with vendor-specific communication.

Further, in some implementations, the one or more first packets may include a sequence number field (such as a CSSN field) that indicates a direction of transmission of the vendor-specific communication during the control sub-event. In some examples, a first bit pattern of the sequence number field indicates that the direction of transmission is broadcaster-to-peripheral and a second bit pattern of the sequence number field indicates that the direction of transmission is peripheral-to-broadcaster. In some examples, a single bit (such as initial bit or a final bit) of the sequence number field is set to either a first bit value or a second bit value to indicate the direction of transmission. In such examples, a remainder of the sequence number field (such as the remaining two bits of the sequence number field) may indicate a sequence number associated with control information (to be) transmitted via the control sub-event, may be used to convey additional information associated with a use purpose of the control sub-event, or may be reserved (such as unused, such as in accordance with the direction of transmission being peripheral-to-broadcaster).

At 810 or 812, the broadcaster device may communicate (such as transmit or receive) control information with one or more peripheral devices (including the peripheral device 804) during the control sub-event in accordance with the one or more first packets indicating that the control sub-event is associated with the vendor-specific communication. In some examples, the control information may be sent via a packet that includes an indication of whether the control information is associated with controller-based information or host-based information. A transmitting device may provide such an indication via an opcode of the packet. In some implementations, such communication may be associated with (such as depend on) whether the indicated direction of transmission associated with the control sub-event is broadcaster-to-peripheral or peripheral-to-broadcaster. If the indicated direction of transmission is broadcaster-to-peripheral, at 810, the broadcaster device 802 may transmit the control information to the one or more peripheral devices (including the peripheral device 804) and, accordingly, the peripheral device 804 may receive the control information. If the indicated direction of transmission is peripheral-to-broadcaster, at 812, the peripheral device 804 may transmit the control information to the broadcaster device 802 and, accordingly, the broadcaster device 802 may receive the control information. Thus, in some implementations, the broadcaster device 802 and the peripheral device 804 may support Bluetooth LE audio (among others, such as display, motion, or other data) broadcast use cases in which the broadcaster device 802 may receive data from one or more broadcast receivers without creating point-to-point connections (as a broadcast receiver may use the control sub-event to communicate with the broadcaster without establishing a point-to-point connection with the broadcaster).

In implementations in which the peripheral device 804 transmits the control information, the peripheral device 804 may determine, select, identify, or otherwise ascertain to transmit the control information during the control sub-event of the first BIG event in accordance with a first BIS stream to which the peripheral device 804 is tuned corresponding to a first BIS index associated with the first BIG event. In other words, the peripheral device 804 may be associated with (such as tuned to) the first BIS that corresponds to the first BIS index and may transmit during the control sub-event of the first BIG event in accordance with the first BIS index being associated with the first BIG event. Put another way, the peripheral device 804 may refrain from transmitting control information during a control sub-event of a BIG event with which the first BIS index is not associated in accordance with a clash avoidance scheme.

The first BIS index may be associated with the first BIG event in accordance with a mapping (such as a mapping indicated at 806), which may take one or more of various forms. In some examples, the mapping may indicate that the first BIS index is associated with the first BIG event in accordance with a modulo operation between a BIG event number of the first BIG event and a total quantity of BISs within the BIG being equal to the first BIS index minus one. In other words, the peripheral device 804 may be associated with a first BIS index n and may transmit during the first BIG event in accordance with “BIG event number” mod “total quantity of BISs”=n−1. In such examples, the mapping between a BIS index n and a BIG event may be associated with a satisfaction of “BIG event number” mod “total quantity of BISs”=n−1. Additionally, or alternatively, the mapping may explicitly indicate a correspondence (via, for example, a mapping or correspondence table) between BIS indices and BIG events. For example, the mapping may indicate that a first BIS index corresponds to a first BIG event number, that a second BIS index corresponds to a second BIG event number, and so on (without use or performance of any further calculation by the broadcaster device 802 or the peripheral device 804).

Additionally, or alternatively, the broadcaster device 802 and the peripheral device 804 may support a power conservation scheme associated with the BIG event number multiple. In such implementations, the peripheral device 804 may transmit the control information via the control sub-event of the first BIG event in accordance with a modulo operation between the BIG event number of the first BIG event and the BIG event number multiple being equal to zero. The broadcaster device 802 may refrain from monitoring control sub-events for which the modulo operation between a BIG event number and the BIG event number multiple is not equal to zero (such as when the modulo operation provides a number or value greater than zero). Additional details relating to such a power conservation scheme, and a combination of power conservation with clash avoidance, are described with reference to FIG. 7.

At 814, the broadcaster device may transmit, via the one or more BISs of the BIG and during one or more second sub-events of a second BIG event, one or more second packets (such as one or more BIS data PDUs) in accordance with the control information. For example, the control information may include a channel assessment by the peripheral device 804, feedback information from the peripheral device 804, an indication of a volume level setting, an indication of a mute setting, or any combination thereof and the broadcaster device 802 may update, tailor, change, (re-)configure, or otherwise adjust one or more communication parameters or packet contents, among other examples, based on the control information. For example, if the peripheral device 804 provided a channel assessment via the control information at 812, the broadcaster device 802 may update a channel map and which channels the broadcaster device 802 uses for broadcast communication in accordance with the channel assessment received from the peripheral device 804.

In some aspects, the content of the control information and the impact the control information has on subsequent packets may depend on (such as be associated with) a use case or deployment scenario involving the broadcaster device 802 and the peripheral device 804. Such use cases may include to enable one or more peripheral devices to provide control feedback to the broadcaster device 802, to enable a broadcast system to synchronize host-based information between peripheral devices (such as within an in-vehicle media system in which speakers receive media from a car-kit, within a home or office audio system in which a TV applies a user-input volume setting to multiple speakers, or within any other similar systems), and to enable an on-boarding of receivers (peripheral devices) with an initial setting (such as a desired initial volume setting). Additional details relating to such example use cases are illustrated by and described with reference to FIGS. 3-5.

At 816, the peripheral device 804 may transmit, and the broadcaster device 802 may receive, a second packet (such as a BIG control PDU) that includes a retransmission of the control information from the peripheral device 804. For example, the peripheral device 804 may transmit the control information at 812 during a first control sub-event of a first BIG event and may retransmit the control information at 816 during a second control sub-event of a second BIG event. In some implementations, the peripheral device 804 may select to retransmit the control information during the second BIG event in accordance with a selected RBO from the first BIG event. In some examples, the second packet may include a sequence number field (such as a CSSN field) indicative of a sequence number associated with the control information. In such examples, the broadcaster device 802 may parse the sequence number field and determine, in accordance with the sequence number associated with the control information, whether the broadcaster device 802 has (successfully) received a prior version of the same control information or whether the broadcaster device 802 has not yet (successfully) received a prior version of the same control information. The broadcaster device 802 may refrain from acting on any duplicate (such as repetitive based on sequence number) control information received from the peripheral device 804 (as the broadcaster device 802 may expect to have already taken relevant action on the first instance of the control information).

Further, although described in the context of exchanging control information via a control sub-event of a BIG event, the broadcaster device 802 and the peripheral device 804 may additionally, or alternatively, leverage one or more other signaling mechanisms to facilitate a bi-directional control information flow between broadcaster and broadcast receiver(s). In some implementations, for example, the broadcaster device 802 may use PA for broadcasting control information to one or more peripheral devices (including the peripheral device 804) and the peripheral device 804 may use a PA response for transmitting control information of the peripheral device 804 to the broadcaster device 802. In such implementations, the peripheral device 804 may transmit the PA response an interframe space (IFS), which also may be referred to as a time TIFS (or a time TIFs), after the PA packet received from the broadcaster device 802. In some examples, the broadcaster device 802 may use an RFU bit in a PA header to indicate if there is vendor-specific information ready from transmission from the broadcaster device 802 to the peripheral device(s) TIFS after the PA, or if the TIFS after space is to be used (such as is available for use) by a peripheral device (such as the peripheral device 804) to transmit to the broadcaster device 802. In other words, the broadcaster device 802 and the peripheral device 804, potentially among other peripheral devices, may leverage a PA with response (PAWR) for broadcasting the control information and a PA response for receiving control information from a broadcaster receiver. If a PAWR indicates that there is vendor-specific information ready from transmission from the broadcaster device 802 to the peripheral device(s) TIFS after the PA, the peripheral device(s) may refrain from transmitting a PA response and instead monitor for the vendor-specific information.

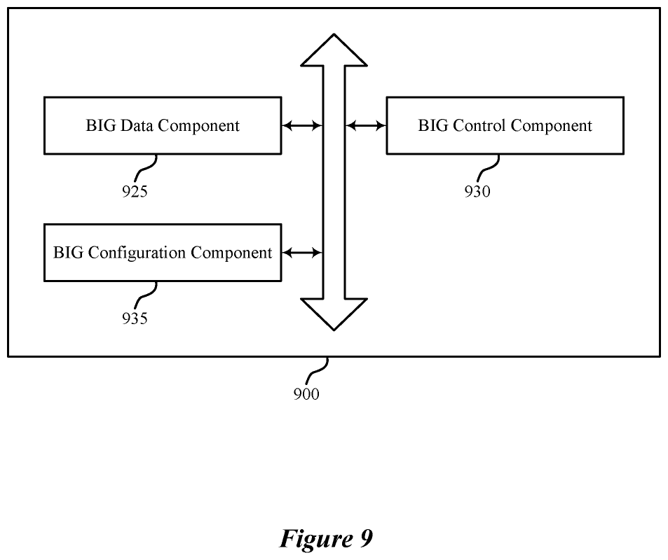

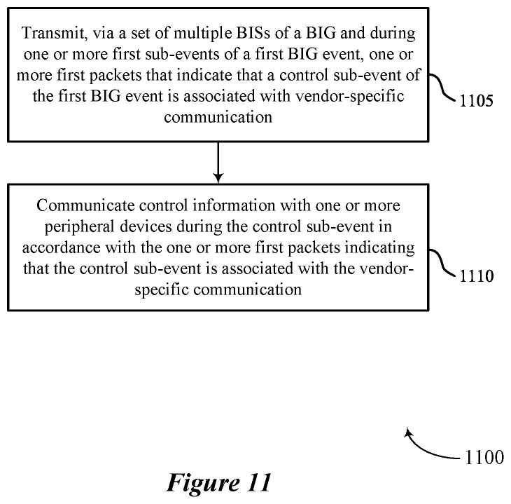

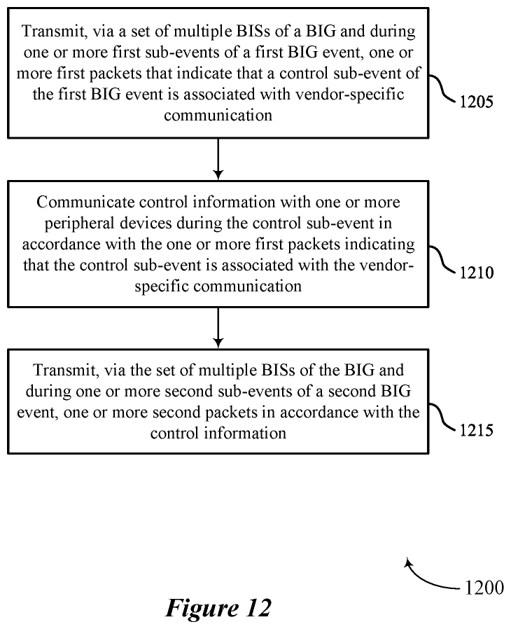

FIG. 9 shows a block diagram of an example wireless communication device 900 that supports LE broadcast control information flow for synchronizing a broadcaster device and one or more peripheral devices. In some examples, the wireless communication device 900 is configured to perform the processes 1100 and 1200 described with reference to FIGS. 11 and 12, respectively. The wireless communication device 900 may include one or more chips, SoCs, chipsets, packages, components or devices that individually or collectively constitute or include a processing system. The processing system may interface with other components of the wireless communication device 900, and may generally process information (such as inputs or signals) received from such other components and output information (such as outputs or signals) to such other components. In some aspects, an example chip may include a processing system, a first interface to output or transmit information and a second interface to receive or obtain information. For example, the first interface may refer to an interface between the processing system of the chip and a transmission component, such that the wireless communication device 900 may transmit the information output from the chip. In such an example, the second interface may refer to an interface between the processing system of the chip and a reception component, such that the wireless communication device 900 may receive information that is passed to the processing system. In some such examples, the first interface also may obtain information, such as from the transmission component, and the second interface also may output information, such as to the reception component.

The processing system of the wireless communication device 900 includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. The processing system may further include memory circuitry in the form of one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). One or more of the memories may be coupled with one or more of the processors and may individually or collectively store processor-executable code that, when executed by one or more of the processors, may configure one or more of the processors to perform various functions or operations described herein. Additionally, or alternatively, in some examples, one or more of the processors may be preconfigured to perform various functions or operations described herein without requiring configuration by software. The processing system may further include or be coupled with one or more modems (such as a Bluetooth modem, a Wi-Fi (such as IEEE compliant) modem, or a cellular (such as 3GPP 4G LTE, 5G or 6G compliant) modem). In some implementations, one or more processors of the processing system include or implement one or more of the modems. The processing system may further include or be coupled with multiple radios (collectively “the radio”), multiple RF chains or multiple transceivers, each of which may in turn be coupled with one or more of multiple antennas. In some implementations, one or more processors of the processing system include or implement one or more of the radios, RF chains or transceivers.

In some examples, the wireless communication device 900 can be configurable or configured for use in a broadcaster device, such as a broadcaster device described with reference to FIGS. 1-8. In some other examples, the wireless communication device 900 can be a broadcaster device that includes such a processing system and other components including multiple antennas. The wireless communication device 900 is capable of transmitting and receiving wireless communications in the form of, for example, wireless packets. For example, the wireless communication device 900 can be configurable or configured to transmit and receive packets in the form of PDUs conforming to a Bluetooth protocol or one or more of the IEEE 802.11 family of wireless communication protocol standards. In some other examples, the wireless communication device 900 can be configurable or configured to transmit and receive signals and communications conforming to one or more 3GPP specifications including those for 5G NR or 6G. In some examples, the wireless communication device 900 also includes or can be coupled with one or more application processors which may be further coupled with one or more other memories. In some examples, the wireless communication device 900 further includes at least one external network interface coupled with the processing system that enables communication with a core network or backhaul network that enables the wireless communication device 900 to gain access to external networks including the Internet.

The wireless communication device 900 includes a BIG data component 925, a BIG control component 930, and a BIG configuration component 935. Portions of one or more of the BIG data component 925, the BIG control component 930, and the BIG configuration component 935 may be implemented at least in part in hardware or firmware. For example, one or more of the BIG data component 925, the BIG control component 930, and the BIG configuration component 935 may be implemented at least in part by at least a processor or a modem. In some examples, portions of one or more of the BIG data component 925, the BIG control component 930, and the BIG configuration component 935 may be implemented at least in part by a processor and software in the form of processor-executable code stored in memory.

The wireless communication device 900 may support wireless communication in accordance with examples as disclosed herein. The BIG data component 925 is configurable or configured to transmit, via a set of multiple BISs of a BIG and during one or more first sub-events of a first BIG event, one or more first packets that indicate that a control sub-event of the first BIG event is associated with vendor-specific communication. The BIG control component 930 is configurable or configured to communicate control information with one or more peripheral devices during the control sub-event in accordance with the one or more first packets indicating that the control sub-event is associated with the vendor-specific communication.

In some examples, the BIG data component 925 is configurable or configured to transmit, via the set of multiple BISs of the BIG and during one or more second sub-events of a second BIG event, one or more second packets in accordance with the control information.

In some examples, the one or more first packets further include a sequence number field. In some examples, the sequence number field indicates a direction of transmission of the control information between the broadcaster device and the one or more peripheral devices in accordance with the one or more first packets indicating that the control sub-event is associated with the vendor-specific communication.

In some examples, a first bit pattern of the sequence number field indicates that the direction of transmission is broadcaster-to-peripheral and a second bit pattern of the sequence number field indicates that the direction of transmission is peripheral-to-broadcaster.

In some examples, to support communicating the control information with the one or more peripheral devices, the BIG control component 930 is configurable or configured to transmit the control information to the one or more peripheral devices in accordance with the sequence number field including the first bit pattern. In some examples, to support communicating the control information with the one or more peripheral devices, the BIG control component 930 is configurable or configured to receive the control information from a peripheral device, of the one or more peripheral devices, in accordance with the sequence number field including the second bit pattern.

In some examples, the sequence number field includes three bits. In some examples, a first bit of the three bits indicates that the direction of transmission is broadcaster-to-peripheral or that the direction of transmission is peripheral-to-broadcaster. In some examples, a remainder of the three bits excluding the first bit indicates a sequence number that is valid in accordance with the first bit indicating that the direction of transmission is broadcaster-to-peripheral.

In some examples, to support communicating the control information with the one or more peripheral devices, the BIG control component 930 is configurable or configured to receive, during the control sub-event, a packet that includes the control information from a first peripheral device, of the one or more peripheral devices, in accordance with the direction of transmission and in accordance with a BIG event number corresponding to the first BIG event.

In some examples, the first peripheral device is associated with a first BIS, of the set of multiple BISs, that corresponds to a first BIS index. In some examples, the first BIS index is associated with the first BIG event. In some examples, receiving the packet from the first peripheral device during the control sub-event of the first BIG event is in accordance with the first BIS index being associated with the first BIG event.

In some examples, the first BIS index is associated with the first BIG event in accordance with a modulo operation between the BIG event number and a quantity of the set of multiple BISs being equal to the first BIS index minus one.

In some examples, the BIG configuration component 935 is configurable or configured to transmit, via configuration information associated with the BIG, an indication of a mapping between BIS indices and BIG events, where the first BIS index is associated with the first BIG event in accordance with the mapping.

In some examples, the BIG control component 930 is configurable or configured to receive, during a second control sub-event of a second BIG event, a second packet that includes a retransmission of the control information from the first peripheral device, where the second BIG event is associated with a random back-off from the first BIG event.

In some examples, the packet includes a second sequence number field indicative of a sequence number associated with the control information.

In some examples, the BIG configuration component 935 is configurable or configured to transmit, via configuration information associated with the BIG, an indication of a BIG event number multiple associated with the vendor-specific communication, where a modulo operation between the BIG event number and the BIG event number multiple is equal to zero.

In some examples, the BIG control component 930 is configurable or configured to refrain from monitoring for the vendor-specific communication during control sub-events of BIG events for which modulo operations between BIG event numbers corresponding to the BIG events and the BIG event number multiple are equal to a number greater than zero.

In some examples, to support communicating the control information with the one or more peripheral devices, the BIG control component 930 is configurable or configured to communicate a packet that includes the control information, where the packet further includes an indication that the control information is associated with controller-based information or host-based information.

In some examples, an opcode of the packet includes the indication that the control information is associated with the controller-based information or the host-based information.

In some examples, the control information includes a channel assessment by a peripheral device of the one or more peripheral devices, feedback information from the peripheral device of the one or more peripheral devices, an indication of a volume level setting, an indication of a mute setting, or any combination thereof.

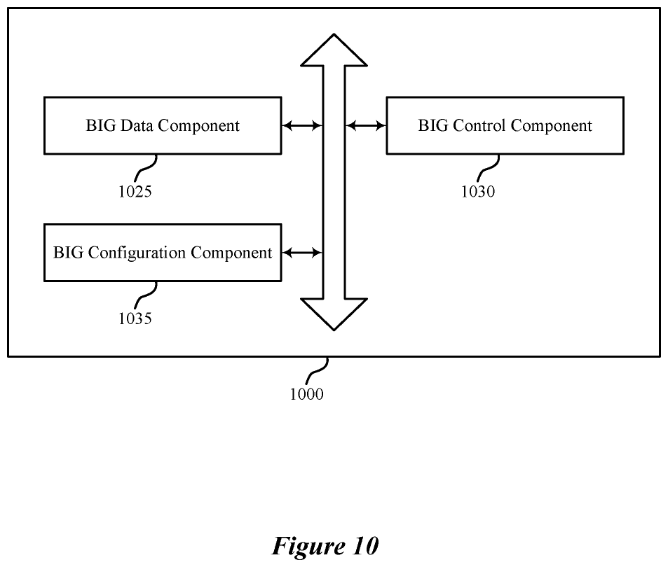

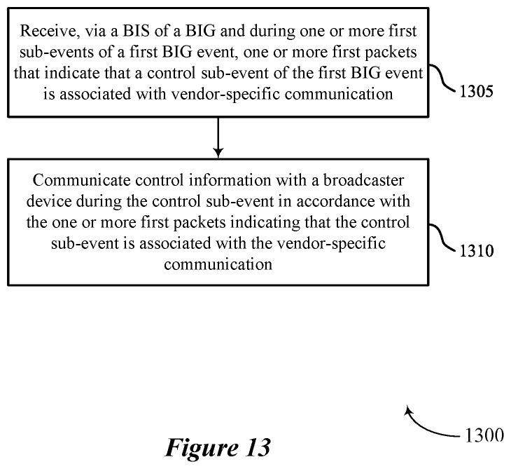

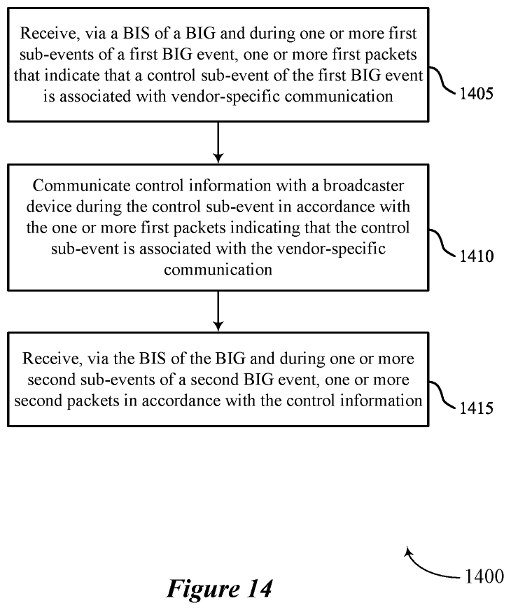

FIG. 10 shows a block diagram of an example wireless communication device 1000 that supports LE broadcast control information flow for synchronizing a broadcaster device and one or more peripheral devices. In some examples, the wireless communication device 1000 is configured to perform the processes 1300 and 1400 described with reference to FIGS. 13 and 14, respectively. The wireless communication device 1000 may include one or more chips, SoCs, chipsets, packages, components or devices that individually or collectively constitute or include a processing system. The processing system may interface with other components of the wireless communication device 1000, and may generally process information (such as inputs or signals) received from such other components and output information (such as outputs or signals) to such other components. In some aspects, an example chip may include a processing system, a first interface to output or transmit information and a second interface to receive or obtain information. For example, the first interface may refer to an interface between the processing system of the chip and a transmission component, such that the wireless communication device 1000 may transmit the information output from the chip. In such an example, the second interface may refer to an interface between the processing system of the chip and a reception component, such that the wireless communication device 1000 may receive information that is passed to the processing system. In some such examples, the first interface also may obtain information, such as from the transmission component, and the second interface also may output information, such as to the reception component.

The processing system of the wireless communication device 1000 includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. The processing system may further include memory circuitry in the form of one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). One or more of the memories may be coupled with one or more of the processors and may individually or collectively store processor-executable code that, when executed by one or more of the processors, may configure one or more of the processors to perform various functions or operations described herein. Additionally, or alternatively, in some examples, one or more of the processors may be preconfigured to perform various functions or operations described herein without requiring configuration by software. The processing system may further include or be coupled with one or more modems (such as a Bluetooth modem, a Wi-Fi (such as IEEE compliant) modem, or a cellular (such as 3GPP 4G LTE, 5G or 6G compliant) modem). In some implementations, one or more processors of the processing system include or implement one or more of the modems. The processing system may further include or be coupled with multiple radios (collectively “the radio”), multiple RF chains or multiple transceivers, each of which may in turn be coupled with one or more of multiple antennas. In some implementations, one or more processors of the processing system include or implement one or more of the radios, RF chains or transceivers.

In some examples, the wireless communication device 1000 can be configurable or configured for use in a peripheral device (such as a broadcast receiver), such as a peripheral device described with reference to FIGS. 1-8. In some other examples, the wireless communication device 1000 can be a peripheral device that includes such a processing system and other components including multiple antennas. The wireless communication device 1000 is capable of transmitting and receiving wireless communications in the form of, for example, wireless packets. For example, the wireless communication device 1000 can be configurable or configured to transmit and receive packets in the form of PDUs conforming to a Bluetooth protocol or one or more of the IEEE 802.11 family of wireless communication protocol standards. In some other examples, the wireless communication device 1000 can be configurable or configured to transmit and receive signals and communications conforming to one or more 3GPP specifications including those for 5G NR or 6G. In some examples, the wireless communication device 1000 also includes or can be coupled with one or more application processors which may be further coupled with one or more other memories. In some examples, the wireless communication device 1000 further includes a UI (such as a touchscreen or keypad) and a display, which may be integrated with the UI to form a touchscreen display that is coupled with the processing system. In some examples, the wireless communication device 1000 may further include one or more sensors such as, for example, one or more inertial sensors, accelerometers, temperature sensors, pressure sensors, or altitude sensors, that are coupled with the processing system.

The wireless communication device 1000 includes a BIG data component 1025, a BIG control component 1030, and a BIG configuration component 1035. Portions of one or more of the BIG data component 1025, the BIG control component 1030, and the BIG configuration component 1035 may be implemented at least in part in hardware or firmware. For example, one or more of the BIG data component 1025, the BIG control component 1030, and the BIG configuration component 1035 may be implemented at least in part by at least a processor or a modem. In some examples, portions of one or more of the BIG data component 1025, the BIG control component 1030, and the BIG configuration component 1035 may be implemented at least in part by a processor and software in the form of processor-executable code stored in memory.

The wireless communication device 1000 may support wireless communication in accordance with examples as disclosed herein. The BIG data component 1025 is configurable or configured to receive, via a BIS of a BIG and during one or more first sub-events of a first BIG event, one or more first packets that indicate that a control sub-event of the first BIG event is associated with vendor-specific communication. The BIG control component 1030 is configurable or configured to communicate control information with a broadcaster device during the control sub-event in accordance with the one or more first packets indicating that the control sub-event is associated with the vendor-specific communication.

In some examples, the BIG data component 1025 is configurable or configured to receive, via the BIS of the BIG and during one or more second sub-events of a second BIG event, one or more second packets in accordance with the control information.

In some examples, the one or more first packets further include a sequence number field. In some examples, the sequence number field indicates a direction of transmission of the control information between the broadcaster device and the peripheral device in accordance with the one or more first packets indicating that the control sub-event is associated with the vendor-specific communication.

In some examples, a first bit pattern of the sequence number field indicates that the direction of transmission is broadcaster-to-peripheral and a second bit pattern of the sequence number field indicates that the direction of transmission is peripheral-to-broadcaster.

In some examples, to support communicating the control information with the broadcaster device, the BIG control component 1030 is configurable or configured to receive the control information from the broadcaster device in accordance with the sequence number field including the first bit pattern. In some examples, to support communicating the control information with the broadcaster device, the BIG control component 1030 is configurable or configured to transmit the control information to the broadcaster device in accordance with the sequence number field including the second bit pattern.

In some examples, the sequence number field includes three bits. In some examples, a first bit of the three bits indicates that the direction of transmission is broadcaster-to-peripheral or that the direction of transmission is peripheral-to-broadcaster. In some examples, a remainder of the three bits excluding the first bit indicates a sequence number that is valid in accordance with the first bit indicating that the direction of transmission is broadcaster-to-peripheral.

In some examples, to support communicating the control information with the broadcaster device, the BIG control component 1030 is configurable or configured to transmit, during the control sub-event of the first BIG event, a packet that includes the control information in accordance with the direction of transmission and in accordance with a BIG event number corresponding to the first BIG event.

In some examples, the BIS corresponds to a BIS index. In some examples, the BIS index is associated with the first BIG event. In some examples, transmitting the packet during the control sub-event of the first BIG event is in accordance with the BIS index being associated with the first BIG event.

In some examples, the BIS index is associated with the first BIG event in accordance with a modulo operation between the BIG event number and a quantity of a set of multiple BISs of the BIG being equal to the BIS index minus one.

In some examples, the BIG configuration component 1035 is configurable or configured to receive, via configuration information associated with the BIG, an indication of a mapping between BIS indices and BIG events, where the BIS index is associated with the first BIG event in accordance with the mapping.

In some examples, the BIG control component 1030 is configurable or configured to transmit, during a second control sub-event of a second BIG event, a second packet that includes a retransmission of the control information, where the second BIG event is associated with a random back-off from the first BIG event.

In some examples, the packet includes a second sequence number field indicative of a sequence number associated with the control information.

In some examples, the BIG configuration component 1035 is configurable or configured to receive, via configuration information associated with the BIG, an indication of a BIG event number multiple associated with the vendor-specific communication, where a modulo operation between the BIG event number and the BIG event number multiple is equal to zero.

In some examples, the BIG control component 1030 is configurable or configured to refrain from transmitting during control sub-events of BIG events for which modulo operations between BIG event numbers corresponding to the BIG events and the BIG event number multiple are equal to a number greater than zero.

In some examples, to support communicating the control information with the broadcaster device, the BIG control component 1030 is configurable or configured to communicate a packet that includes the control information, where the packet further includes an indication that the control information is associated with controller-based information or host-based information.

In some examples, an opcode of the packet includes the indication that the control information is associated with the controller-based information or the host-based information.

In some examples, the control information includes a channel assessment by the peripheral device, feedback information from the peripheral device, an indication of a volume level setting, an indication of a mute setting, or any combination thereof.

FIG. 11 shows a flowchart illustrating an example process 1100 performable by or at a broadcaster device that supports LE broadcast control information flow for synchronizing a broadcaster device and one or more peripheral devices. The operations of the process 1100 may be implemented by a broadcaster device or its components as described herein. For example, the process 1100 may be performed by a wireless communication device, such as the wireless communication device 900 described with reference to FIG. 9, operating as or within a broadcaster device. In some examples, the process 1100 may be performed by a broadcaster device, such as a broadcaster device described with reference to FIGS. 1-8.

In some examples, in 1105, the broadcaster device may transmit, via a set of multiple BISs of a BIG and during one or more first sub-events of a first BIG event, one or more first packets that indicate that a control sub-event of the first BIG event is associated with vendor-specific communication. The operations of 1105 may be performed in accordance with examples as disclosed herein. In some implementations, aspects of the operations of 1105 may be performed by a BIG data component 925 as described with reference to FIG. 9.

In some examples, in 1110, the broadcaster device may communicate control information with one or more peripheral devices during the control sub-event in accordance with the one or more first packets indicating that the control sub-event is associated with the vendor-specific communication. The operations of 1110 may be performed in accordance with examples as disclosed herein. In some implementations, aspects of the operations of 1110 may be performed by a BIG control component 930 as described with reference to FIG. 9.

FIG. 12 shows a flowchart illustrating an example process 1200 performable by or at a broadcaster device that supports LE broadcast control information flow for synchronizing a broadcaster device and one or more peripheral devices. The operations of the process 1200 may be implemented by a broadcaster device or its components as described herein. For example, the process 1200 may be performed by a wireless communication device, such as the wireless communication device 900 described with reference to FIG. 9, operating as or within a broadcaster device. In some examples, the process 1200 may be performed by a broadcaster device, such as a broadcaster device described with reference to FIGS. 1-8.

In some examples, in 1205, the broadcaster device may transmit, via a set of multiple BISs of a BIG and during one or more first sub-events of a first BIG event, one or more first packets that indicate that a control sub-event of the first BIG event is associated with vendor-specific communication. The operations of 1205 may be performed in accordance with examples as disclosed herein. In some implementations, aspects of the operations of 1205 may be performed by a BIG data component 925 as described with reference to FIG. 9.

In some examples, in 1210, the broadcaster device may communicate control information with one or more peripheral devices during the control sub-event in accordance with the one or more first packets indicating that the control sub-event is associated with the vendor-specific communication. The operations of 1210 may be performed in accordance with examples as disclosed herein. In some implementations, aspects of the operations of 1210 may be performed by a BIG control component 930 as described with reference to FIG. 9.

In some examples, in 1215, the broadcaster device may transmit, via the set of multiple BISs of the BIG and during one or more second sub-events of a second BIG event, one or more second packets in accordance with the control information. The operations of 1215 may be performed in accordance with examples as disclosed herein. In some implementations, aspects of the operations of 1215 may be performed by a BIG data component 925 as described with reference to FIG. 9.

FIG. 13 shows a flowchart illustrating an example process 1300 performable by or at a peripheral device that supports LE broadcast control information flow for synchronizing a broadcaster device and one or more peripheral devices. The operations of the process 1300 may be implemented by a peripheral device or its components as described herein. For example, the process 1300 may be performed by a wireless communication device, such as the wireless communication device 1000 described with reference to FIG. 10, operating as or within a peripheral device. In some examples, the process 1300 may be performed by a peripheral device, such as a peripheral device described with reference to FIGS. 1-8.

In some examples, in 1305, the peripheral device may receive, via a BIS of a BIG and during one or more first sub-events of a first BIG event, one or more first packets that indicate that a control sub-event of the first BIG event is associated with vendor-specific communication. The operations of 1305 may be performed in accordance with examples as disclosed herein. In some implementations, aspects of the operations of 1305 may be performed by a BIG data component 1025 as described with reference to FIG. 10.

In some examples, in 1310, the peripheral device may communicate control information with a broadcaster device during the control sub-event in accordance with the one or more first packets indicating that the control sub-event is associated with the vendor-specific communication. The operations of 1310 may be performed in accordance with examples as disclosed herein. In some implementations, aspects of the operations of 1310 may be performed by a BIG control component 1030 as described with reference to FIG. 10.

FIG. 14 shows a flowchart illustrating an example process 1400 performable by or at a peripheral device that supports LE broadcast control information flow for synchronizing a broadcaster device and one or more peripheral devices. The operations of the process 1400 may be implemented by a peripheral device or its components as described herein. For example, the process 1400 may be performed by a wireless communication device, such as the wireless communication device 1000 described with reference to FIG. 10, operating as or within a peripheral device. In some examples, the process 1400 may be performed by a peripheral device, such as a peripheral device described with reference to FIGS. 1-8.

In some examples, in 1405, the peripheral device may receive, via a BIS of a BIG and during one or more first sub-events of a first BIG event, one or more first packets that indicate that a control sub-event of the first BIG event is associated with vendor-specific communication. The operations of 1405 may be performed in accordance with examples as disclosed herein. In some implementations, aspects of the operations of 1405 may be performed by a BIG data component 1025 as described with reference to FIG. 10.

In some examples, in 1410, the peripheral device may communicate control information with a broadcaster device during the control sub-event in accordance with the one or more first packets indicating that the control sub-event is associated with the vendor-specific communication. The operations of 1410 may be performed in accordance with examples as disclosed herein. In some implementations, aspects of the operations of 1410 may be performed by a BIG control component 1030 as described with reference to FIG. 10.

In some examples, in 1415, the peripheral device may receive, via the BIS of the BIG and during one or more second sub-events of a second BIG event, one or more second packets in accordance with the control information. The operations of 1415 may be performed in accordance with examples as disclosed herein. In some implementations, aspects of the operations of 1415 may be performed by a BIG data component 1025 as described with reference to FIG. 10.

Implementation examples are described in the following numbered clauses:

Clause 1: A method for wireless communication by a broadcaster device, including: transmitting, via a plurality of BISs of a BIG and during one or more first sub-events of a first BIG event, one or more first packets that indicate that a control sub-event of the first BIG event is associated with vendor-specific communication; and communicating control information with one or more peripheral devices during the control sub-event in accordance with the one or more first packets indicating that the control sub-event is associated with the vendor-specific communication.

Clause 2: The method of clause 1, further including: transmitting, via the plurality of BISs of the BIG and during one or more second sub-events of a second BIG event, one or more second packets in accordance with the control information.

Clause 3: The method of any of clauses 1-2, where the one or more first packets further include a sequence number field, and the sequence number field indicates a direction of transmission of the control information between the broadcaster device and the one or more peripheral devices in accordance with the one or more first packets indicating that the control sub-event is associated with the vendor-specific communication.

Clause 4: The method of clause 3, where a first bit pattern of the sequence number field indicates that the direction of transmission is broadcaster-to-peripheral and a second bit pattern of the sequence number field indicates that the direction of transmission is peripheral-to-broadcaster.

Clause 5: The method of clause 4, where communicating the control information with the one or more peripheral devices includes: transmitting the control information to the one or more peripheral devices in accordance with the sequence number field including the first bit pattern; or receiving the control information from a peripheral device, of the one or more peripheral devices, in accordance with the sequence number field including the second bit pattern.

Clause 6: The method of any of clauses 4-5, where the sequence number field includes three bits, a first bit of the three bits indicates that the direction of transmission is broadcaster-to-peripheral or that the direction of transmission is peripheral-to-broadcaster, and a remainder of the three bits excluding the first bit indicates a sequence number that is valid in accordance with the first bit indicating that the direction of transmission is broadcaster-to-peripheral.

Clause 7: The method of any of clauses 3-6, where the sequence number field indicates that the direction of transmission is peripheral-to-broadcaster, where communicating the control information with the one or more peripheral devices includes: receiving, during the control sub-event, a packet that includes the control information from a first peripheral device, of the one or more peripheral devices, in accordance with the direction of transmission and in accordance with a BIG event number corresponding to the first BIG event.

Clause 8: The method of clause 7, where the first peripheral device is associated with a first BIS, of the plurality of BISs, that corresponds to a first BIS index, the first BIS index is associated with the first BIG event, and receiving the packet from the first peripheral device during the control sub-event of the first BIG event is in accordance with the first BIS index being associated with the first BIG event.

Clause 9: The method of clause 8, where the first BIS index is associated with the first BIG event in accordance with a modulo operation between the BIG event number and a quantity of the plurality of BISs being equal to the first BIS index minus one.

Clause 10: The method of any of clauses 8-9, further including: transmitting, via configuration information associated with the BIG, an indication of a mapping between BIS indices and BIG events, where the first BIS index is associated with the first BIG event in accordance with the mapping.

Clause 11: The method of any of clauses 7-10, further including: receiving, during a second control sub-event of a second BIG event, a second packet that includes a retransmission of the control information from the first peripheral device, where the second BIG event is associated with a random back-off from the first BIG event.

Clause 12: The method of any of clauses 7-11, where the packet includes a second sequence number field indicative of a sequence number associated with the control information.

Clause 13: The method of any of clauses 7-12, further including: transmitting, via configuration information associated with the BIG, an indication of a BIG event number multiple associated with the vendor-specific communication, where a modulo operation between the BIG event number and the BIG event number multiple is equal to zero.

Clause 14: The method of clause 13, further including: refraining from monitoring for the vendor-specific communication during control sub-events of BIG events for which modulo operations between BIG event numbers corresponding to the BIG events and the BIG event number multiple are equal to a number greater than zero.

Clause 15: The method of any of clauses 1-14, where communicating the control information with the one or more peripheral devices includes: communicating a packet that includes the control information, where the packet further includes an indication that the control information is associated with controller-based information or host-based information.

Clause 16: The method of clause 15, where an opcode of the packet includes the indication that the control information is associated with the controller-based information or the host-based information.

Clause 17: The method of any of clauses 1-16, where the control information includes a channel assessment by a peripheral device of the one or more peripheral devices, feedback information from the peripheral device of the one or more peripheral devices, an indication of a volume level setting, an indication of a mute setting, or any combination thereof.

Clause 18: A method for wireless communication by a peripheral device, including: receiving, via a BIS of a BIG and during one or more first sub-events of a first BIG event, one or more first packets that indicate that a control sub-event of the first BIG event is associated with vendor-specific communication; and communicating control information with a broadcaster device during the control sub-event in accordance with the one or more first packets indicating that the control sub-event is associated with the vendor-specific communication.

Clause 19: The method of clause 18, further including: receiving, via the BIS of the BIG and during one or more second sub-events of a second BIG event, one or more second packets in accordance with the control information.

Clause 20: The method of any of clauses 18-19, where the one or more first packets further include a sequence number field, and the sequence number field indicates a direction of transmission of the control information between the broadcaster device and the peripheral device in accordance with the one or more first packets indicating that the control sub-event is associated with the vendor-specific communication.

Clause 21: The method of clause 20, where a first bit pattern of the sequence number field indicates that the direction of transmission is broadcaster-to-peripheral and a second bit pattern of the sequence number field indicates that the direction of transmission is peripheral-to-broadcaster.

Clause 22: The method of clause 21, where communicating the control information with the broadcaster device includes: receiving the control information from the broadcaster device in accordance with the sequence number field including the first bit pattern; or transmitting the control information to the broadcaster device in accordance with the sequence number field including the second bit pattern.

Clause 23: The method of any of clauses 21-22, where the sequence number field includes three bits, a first bit of the three bits indicates that the direction of transmission is broadcaster-to-peripheral or that the direction of transmission is peripheral-to-broadcaster, and a remainder of the three bits excluding the first bit indicates a sequence number that is valid in accordance with the first bit indicating that the direction of transmission is broadcaster-to-peripheral.

Clause 24: The method of any of clauses 20-23, where the sequence number field indicates that the direction of transmission is peripheral-to-broadcaster, where communicating the control information with the broadcaster device includes: transmitting, during the control sub-event of the first BIG event, a packet that includes the control information in accordance with the direction of transmission and in accordance with a BIG event number corresponding to the first BIG event.

Clause 25: The method of clause 24, where the BIS corresponds to a BIS index, the BIS index is associated with the first BIG event, and transmitting the packet during the control sub-event of the first BIG event is in accordance with the BIS index being associated with the first BIG event.

Clause 26: The method of clause 25, where the BIS index is associated with the first BIG event in accordance with a modulo operation between the BIG event number and a quantity of a plurality of BISs of the BIG being equal to the BIS index minus one.

Clause 27: The method of any of clauses 25-26, further including: receiving, via configuration information associated with the BIG, an indication of a mapping between BIS indices and BIG events, where the BIS index is associated with the first BIG event in accordance with the mapping.

Clause 28: The method of any of clauses 24-27, further including: transmitting, during a second control sub-event of a second BIG event, a second packet that includes a retransmission of the control information, where the second BIG event is associated with a random back-off from the first BIG event.

Clause 29: The method of any of clauses 24-28, where the packet includes a second sequence number field indicative of a sequence number associated with the control information.

Clause 30: The method of any of clauses 24-29, further including: receiving, via configuration information associated with the BIG, an indication of a BIG event number multiple associated with the vendor-specific communication, where a modulo operation between the BIG event number and the BIG event number multiple is equal to zero.

Clause 31: The method of clause 30, further including: refraining from transmitting during control sub-events of BIG events for which modulo operations between BIG event numbers corresponding to the BIG events and the BIG event number multiple are equal to a number greater than zero.

Clause 32: The method of any of clauses 18-31, where communicating the control information with the broadcaster device includes: communicating a packet that includes the control information, where the packet further includes an indication that the control information is associated with controller-based information or host-based information.

Clause 33: The method of clause 32, where an opcode of the packet includes the indication that the control information is associated with the controller-based information or the host-based information.

Clause 34: The method of any of clauses 18-33, where the control information includes a channel assessment by the peripheral device, feedback information from the peripheral device, an indication of a volume level setting, an indication of a mute setting, or any combination thereof.

Clause 35: A broadcaster device, including one or more memories storing processor-executable code, and one or more processors coupled with the one or more memories and individually or collectively operable to execute the code to cause the broadcaster device to perform a method of any of clauses 1-17.

Clause 35: A broadcaster device, including a processing system that includes processor circuitry and memory circuitry that stores code, the processing system configured to cause the broadcaster device to perform a method of any of clauses 1-17.

Clause 36: A broadcaster device, including at least one means for performing a method of any of clauses 1-17.

Clause 37: A non-transitory computer-readable medium storing code for wireless communication, the code including instructions executable by a processing system (including one or more processors) to perform a method of any of clauses 1-17.

Clause 38: A peripheral device, including one or more memories storing processor-executable code, and one or more processors coupled with the one or more memories and individually or collectively operable to execute the code to cause the peripheral device to perform a method of any of clauses 18-34.

Clause 38: A peripheral device, including a processing system that includes processor circuitry and memory circuitry that stores code, the processing system configured to cause the peripheral device to perform a method of any of clauses 18-34.

Clause 39: A peripheral device, including at least one means for performing a method of any of clauses 18-34.

Clause 40: A non-transitory computer-readable medium storing code for wireless communication, the code including instructions executable by a processing system (including one or more processors) to perform a method of any of clauses 18-34.

As used herein, the term “determine” or “determining” encompasses a wide variety of actions and, therefore, “determining” can include calculating, computing, processing, deriving, estimating, investigating, looking up (such as via looking up in a table, a database, or another data structure), inferring, ascertaining, or measuring, among other possibilities. Also, “determining” can include receiving (such as receiving information), accessing (such as accessing data stored in memory) or transmitting (such as transmitting information), among other possibilities. Additionally, “determining” can include resolving, selecting, obtaining, choosing, establishing and other such similar actions.

As used herein, a phrase referring to “at least one of” or “one or more of” a list of items refers to any combination of those items, including single members. As an example, “at least one of: a, b, or c” is intended to cover: a, b, c, a-b, a-c, b-c, and a-b-c. As used herein, “or” is intended to be interpreted in the inclusive sense, unless otherwise explicitly indicated. For example, “a or b” may include a only, b only, or a combination of a and b. Furthermore, as used herein, a phrase referring to “a” or “an” element refers to one or more of such elements acting individually or collectively to perform the recited function(s). Additionally, a “set” refers to one or more items, and a “subset” refers to less than a whole set, but non-empty.

As used herein, “based on” is intended to be interpreted in the inclusive sense, unless otherwise explicitly indicated. For example, “based on” may be used interchangeably with “based at least in part on,” “associated with,” “in association with,” or “in accordance with” unless otherwise explicitly indicated. Specifically, unless a phrase refers to “based on only ‘a,’” or the equivalent in context, whatever it is that is “based on ‘a,’” or “based at least in part on ‘a,’” may be based on “a” alone or based on a combination of “a” and one or more other factors, conditions, or information.

The various illustrative components, logic, logical blocks, modules, circuits, operations, and algorithm processes described in connection with the examples disclosed herein may be implemented as electronic hardware, firmware, software, or combinations of hardware, firmware, or software, including the structures disclosed in this specification and the structural equivalents thereof. The interchangeability of hardware, firmware and software has been described generally, in terms of functionality, and illustrated in the various illustrative components, blocks, modules, circuits and processes described above. Whether such functionality is implemented in hardware, firmware or software depends upon the particular application and design constraints imposed on the overall system.

Various modifications to the examples described in this disclosure may be readily apparent to persons having ordinary skill in the art, and the generic principles defined herein may be applied to other examples without departing from the spirit or scope of this disclosure. Thus, the claims are not intended to be limited to the examples shown herein, but are to be accorded the widest scope consistent with this disclosure, the principles and the novel features disclosed herein.

Additionally, various features that are described in this specification in the context of separate examples also can be implemented in combination in a single implementation. Conversely, various features that are described in the context of a single implementation also can be implemented in multiple examples separately or in any suitable subcombination. As such, although features may be described above as acting in particular combinations, and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one or more example processes in the form of a flowchart or flow diagram. However, other operations that are not depicted can be incorporated in the example processes that are schematically illustrated. For example, one or more additional operations can be performed before, after, simultaneously, or between any of the illustrated operations. In some circumstances, multitasking and parallel processing may be advantageous. Moreover, the separation of various system components in the examples described above should not be understood as requiring such separation in all examples, and it should be understood that the described program components and systems can generally be integrated together in a single software product or packaged into multiple software products.

What is claimed is:

1. A broadcaster device, comprising:
a processing system that includes processor circuitry and memory circuitry that stores code, the processing system configured to cause the broadcaster device to:
transmit, via a plurality of broadcast isochronous streams of a broadcast isochronous group and during one or more first sub-events of a first broadcast isochronous group event, one or more first packets that indicate that a control sub-event of the first broadcast isochronous group event is associated with vendor-specific communication; and
communicate control information with one or more peripheral devices during the control sub-event in accordance with the one or more first packets indicating that the control sub-event is associated with the vendor-specific communication.

2. The broadcaster device of claim 1, wherein the processing system is further configured to cause the broadcaster device to:
transmit, via the plurality of broadcast isochronous streams of the broadcast isochronous group and during one or more second sub-events of a second broadcast isochronous group event, one or more second packets in accordance with the control information.

3. The broadcaster device of claim 1, wherein the one or more first packets further include a sequence number field, and wherein the sequence number field indicates a direction of transmission of the control information between the broadcaster device and the one or more peripheral devices in accordance with the one or more first packets indicating that the control sub-event is associated with the vendor-specific communication.

4. The broadcaster device of claim 3, wherein a first bit pattern of the sequence number field indicates that the direction of transmission is broadcaster-to-peripheral and a second bit pattern of the sequence number field indicates that the direction of transmission is peripheral-to-broadcaster.

5. The broadcaster device of claim 4, wherein, to communicate the control information with the one or more peripheral devices, the processing system is configured to cause the broadcaster device to:
transmit the control information to the one or more peripheral devices in accordance with the sequence number field including the first bit pattern; or
receive the control information from a peripheral device, of the one or more peripheral devices, in accordance with the sequence number field including the second bit pattern.

6. The broadcaster device of claim 4, wherein the sequence number field includes three bits, wherein a first bit of the three bits indicates that the direction of transmission is broadcaster-to-peripheral or that the direction of transmission is peripheral-to-broadcaster, and wherein a remainder of the three bits excluding the first bit indicates a sequence number that is valid in accordance with the first bit indicating that the direction of transmission is broadcaster-to-peripheral.

7. The broadcaster device of claim 3, wherein, to communicate the control information with the one or more peripheral devices, the processing system is configured to cause the broadcaster device to:
receive, during the control sub-event, a packet that includes the control information from a first peripheral device, of the one or more peripheral devices, in accordance with the direction of transmission and in accordance with a broadcast isochronous group event number corresponding to the first broadcast isochronous group event.

8. The broadcaster device of claim 7, wherein the first peripheral device is associated with a first broadcast isochronous stream, of the plurality of broadcast isochronous streams, that corresponds to a first broadcast isochronous stream index, wherein the first broadcast isochronous stream index is associated with the first broadcast isochronous group event, and wherein receiving the packet from the first peripheral device during the control sub-event of the first broadcast isochronous group event is in accordance with the first broadcast isochronous stream index being associated with the first broadcast isochronous group event.

9. The broadcaster device of claim 8, wherein the first broadcast isochronous stream index is associated with the first broadcast isochronous group event in accordance with a modulo operation between the broadcast isochronous group event number and a quantity of the plurality of broadcast isochronous streams being equal to the first broadcast isochronous stream index minus one.

10. The broadcaster device of claim 8, wherein the processing system is further configured to cause the broadcaster device to:
transmit, via configuration information associated with the broadcast isochronous group, an indication of a mapping between broadcast isochronous stream indices and broadcast isochronous group events, wherein the first broadcast isochronous stream index is associated with the first broadcast isochronous group event in accordance with the mapping.

11. The broadcaster device of claim 7, wherein the processing system is further configured to cause the broadcaster device to:
receive, during a second control sub-event of a second broadcast isochronous group event, a second packet that includes a retransmission of the control information from the first peripheral device, wherein the second broadcast isochronous group event is associated with a random back-off from the first broadcast isochronous group event.

12. The broadcaster device of claim 7, wherein the packet includes a second sequence number field indicative of a sequence number associated with the control information.

13. The broadcaster device of claim 7, wherein the processing system is further configured to cause the broadcaster device to:
transmit, via configuration information associated with the broadcast isochronous group, an indication of a broadcast isochronous group event number multiple associated with the vendor-specific communication, wherein a modulo operation between the broadcast isochronous group event number and the broadcast isochronous group event number multiple is equal to zero.

14. The broadcaster device of claim 13, wherein the processing system is further configured to cause the broadcaster device to:
refrain from monitoring for the vendor-specific communication during control sub-events of broadcast isochronous group events for which modulo operations between broadcast isochronous group event numbers corresponding to the broadcast isochronous group events and the broadcast isochronous group event number multiple are equal to a number greater than zero.

15. The broadcaster device of claim 1, wherein, to communicate the control information with the one or more peripheral devices, the processing system is configured to cause the broadcaster device to:
communicate a packet that includes the control information, wherein the packet further includes an indication that the control information is associated with controller-based information or host-based information.

16. The broadcaster device of claim 15, wherein an opcode of the packet includes the indication that the control information is associated with the controller-based information or the host-based information.

17. The broadcaster device of claim 1, wherein the control information includes a channel assessment by a peripheral device of the one or more peripheral devices, feedback information from the peripheral device of the one or more peripheral devices, an indication of a volume level setting, an indication of a mute setting, or any combination thereof.

18. A peripheral device, comprising:
a processing system that includes processor circuitry and memory circuitry that stores code, the processing system configured to cause the peripheral device to:
receive, via a broadcast isochronous stream of a broadcast isochronous group and during one or more first sub-events of a first broadcast isochronous group event, one or more first packets that indicate that a control sub-event of the first broadcast isochronous group event is associated with vendor-specific communication; and
communicate control information with a broadcaster device during the control sub-event in accordance with the one or more first packets indicating that the control sub-event is associated with the vendor-specific communication.

19. The peripheral device of claim 18, wherein the processing system is further configured to cause the peripheral device to:
receive, via the broadcast isochronous stream of the broadcast isochronous group and during one or more second sub-events of a second broadcast isochronous group event, one or more second packets in accordance with the control information.

20. The peripheral device of claim 18, wherein the one or more first packets further include a sequence number field, and wherein the sequence number field indicates a direction of transmission of the control information between the broadcaster device and the peripheral device in accordance with the one or more first packets indicating that the control sub-event is associated with the vendor-specific communication.

21. The peripheral device of claim 20, wherein a first bit pattern of the sequence number field indicates that the direction of transmission is broadcaster-to-peripheral and a second bit pattern of the sequence number field indicates that the direction of transmission is peripheral-to-broadcaster.

22. The peripheral device of claim 21, wherein, to communicate the control information with the broadcaster device, the processing system is configured to cause the peripheral device to:
receive the control information from the broadcaster device in accordance with the sequence number field including the first bit pattern; or
transmit the control information to the broadcaster device in accordance with the sequence number field including the second bit pattern.

23. The peripheral device of claim 21, wherein the sequence number field includes three bits, wherein a first bit of the three bits indicates that the direction of transmission is broadcaster-to-peripheral or that the direction of transmission is peripheral-to-broadcaster, and wherein a remainder of the three bits excluding the first bit indicates a sequence number that is valid in accordance with the first bit indicating that the direction of transmission is broadcaster-to-peripheral.

24. The peripheral device of claim 20, wherein, to communicate the control information with the broadcaster device, the processing system is configured to cause the peripheral device to:
transmit, during the control sub-event of the first broadcast isochronous group event, a packet that includes the control information in accordance with the direction of transmission and in accordance with a broadcast isochronous group event number corresponding to the first broadcast isochronous group event.

25. The peripheral device of claim 24, wherein the broadcast isochronous stream corresponds to a broadcast isochronous stream index, wherein the broadcast isochronous stream index is associated with the first broadcast isochronous group event, and wherein transmitting the packet during the control sub-event of the first broadcast isochronous group event is in accordance with the broadcast isochronous stream index being associated with the first broadcast isochronous group event.

26. The peripheral device of claim 25, wherein the broadcast isochronous stream index is associated with the first broadcast isochronous group event in accordance with a modulo operation between the broadcast isochronous group event number and a quantity of a plurality of broadcast isochronous streams of the broadcast isochronous group being equal to the broadcast isochronous stream index minus one.

27. The peripheral device of claim 25, wherein the processing system is further configured to cause the peripheral device to:
receive, via configuration information associated with the broadcast isochronous group, an indication of a mapping between broadcast isochronous stream indices and broadcast isochronous group events, wherein the broadcast isochronous stream index is associated with the first broadcast isochronous group event in accordance with the mapping.

28. The peripheral device of claim 24, wherein the processing system is further configured to cause the peripheral device to:
transmit, during a second control sub-event of a second broadcast isochronous group event, a second packet that includes a retransmission of the control information, wherein the second broadcast isochronous group event is associated with a random back-off from the first broadcast isochronous group event.

29. A method for wireless communication by a broadcaster device, comprising:
transmitting, via a plurality of broadcast isochronous streams of a broadcast isochronous group and during one or more first sub-events of a first broadcast isochronous group event, one or more first packets that indicate that a control sub-event of the first broadcast isochronous group event is associated with vendor-specific communication; and
communicating control information with one or more peripheral devices during the control sub-event in accordance with the one or more first packets indicating that the control sub-event is associated with the vendor-specific communication.

30. A method for wireless communication by a peripheral device, comprising:
receiving, via a broadcast isochronous stream of a broadcast isochronous group and during one or more first sub-events of a first broadcast isochronous group event, one or more first packets that indicate that a control sub-event of the first broadcast isochronous group event is associated with vendor-specific communication; and
communicating control information with a broadcaster device during the control sub-event in accordance with the one or more first packets indicating that the control sub-event is associated with the vendor-specific communication.
